(19) United States
(12) Patent Application Publication
(10) Pub. No.: US 2012/0160217 A1
(43) Pub. Date: Jun. 28, 2012

(54) COMBUSTION PRESSURE CONTROLLER

(75) Inventor: Takeshi Ashizawa, Yokohama-shi (JP)

(73) Assignee: TOYOTA JIDOSHA KABUSHIKI KAISHA, Toyota-shi ,Aichi (JP)

(21) Appl. No.: 13/392,535

(22) PCT Filed: Sep. 11, 2009
(86) PCT No.: PCT/JP2009/066327

§ 371 Date: Feb. 27, 2012

(51) Int. Cl. F02D 15/04

(52) U.S. Cl. 123/48 D

(57) ABSTRACT

A combustion pressure control system of a spark ignition type of internal combustion engine which has a sub chamber 60 which is communicated with a combustion chamber 5, wherein the system is provided with a volume changing device which changes a volume of the sub chamber 60 by a change of pressure of the combustion chamber 5 serving as a driving source when the pressure of the combustion chamber 5 reaches a control pressure. The control pressure is set in a range of larger than a maximum pressure of the combustion chamber 5 in the case of suspending the supply of fuel and less than the pressure at which abnormal combustion of the fuel occurs. The volume changing device is formed so that when the pressure of the combustion chamber 5 reaches the control pressure during the period from a compression stroke to an expansion stroke of a combustion cycle, the volume of the sub chamber 60 becomes larger and a rise of the pressure of the combustion chamber 5 is suppressed.

### TECHNICAL FIELD

The present invention relates to a combustion pressure control system.

### BACKGROUND ART

In an internal combustion engine, a combustion chamber is fed with fuel and air and the fuel is burned in the combustion chamber to output a drive force. When making fuel burn in a combustion chamber, the mixture of the air and fuel is compressed and the fuel made to burn in that state. It is known that the compression ratio of an internal combustion engine affects the output and the amount of fuel consumption. By making the compression ratio higher, an output torque can be increased and the amount of fuel consumption can be decreased.

Japanese Patent Publication (A) No. 7-229431 discloses an internal combustion engine which is provided with a piston which is arranged slidably at the inside of a housing which is fastened to a cylinder block and a sleeve which is arranged slidably at the inside of the piston. This internal combustion engine forms, at the inside of the piston, a gas chamber through a throttling portion. The gas chamber is communicated with a combustion chamber. The pressure inside of the combustion chamber considerably fluctuates in the intake stroke, the compression stroke, the expansion stroke, and the exhaust stroke, but due to the throttling action, the pressure of the gas chamber is maintained at substantially the average value of the gas pressure of the combustion chamber. In this internal combustion engine, if the average value of the gas pressure inside the combustion chamber becomes higher, the piston moves in a direction away from the combustion chamber. It is disclosed that during the period of one combustion cycle, a certain piston position is maintained and the volume of the part where the fuel burns becomes larger.

Japanese Patent Publication (A) No. 2000-230439 discloses a self-ignition type of internal combustion engine which is provided with a sub chamber which communicates with a combustion chamber through a pressure regulator, wherein the pressure regulator has a valve element and a valve rod which is connected to the valve element and is biased to the combustion chamber side. It discloses that this self-ignition type of internal combustion engine pushes up the pressure regulator against the pressure of an elastic member to release the pressure to the sub chamber when overly early ignition etc. causes the combustion pressure to exceed a predetermined allowable pressure value. This publication discloses that the pressure regulator operates by a pressure larger than the pressure caused by overly early ignition etc.

Japanese Patent Publication (A) No. 10-205332 discloses a self-ignition type of engine which is provided with a main chamber with a pressure reducing chamber and arranges a sub piston which is biased by a spring force in the pressure reducing chamber. In this engine, at the time of a compression stroke, part of the compressed air of the main chamber is stored in the pressure reducing chamber. Next, at the time of an expansion stroke, the compressed air which was stored at the pressure reducing chamber pushes against the main chamber due to the spring force. This publication discloses storing in the pressure reducing chamber only air which was compressed before starting to burn the fuel. This publication discloses that the sub piston starts moving when the pressure is less than the maximum tube pressure when the fuel does not burn.

Japanese Patent Publication (A) No. 2003-526043 discloses a self-ignition type of engine where two chambers are connected to each other, where one chamber is a combustion chamber and the other chamber includes a power transmission member. In this engine, the piston is arranged at the combustion chamber, and the piston is connected to a computer-controlled ram. It is disclosed that, by control of the ram, the position of the piston is determined and the volume of the combustion chamber is changed. This publication discloses to intentionally change the compression ratios of the respective combustion volumes so as to adjust the timing of self-ignition of the air-fuel mixture.

### CITATION LIST

### Patent Literature

PLT 1: Japanese Patent Publication (A) No. 7-229431
PLT 2: Japanese Patent Publication (A) No. 2000-230439
PLT 3: Japanese Patent Publication (A) No. 10-205332
PLT 4: Japanese Patent Publication (A) No. 2003-526043

### SUMMARY OF INVENTION

### Technical Problem

In a spark ignition type of internal combustion engine, a mixture of fuel and air is ignited by an ignition device in the combustion chamber, whereby the air-fuel mixture burns and the piston is pushed down. At this time, by raising the compression ratio, the heat efficiency is improved. In this regard, if raising the compression ratio, sometimes abnormal combustion occurs. For example, due to the compression ratio becoming higher, sometimes a self-ignition phenomenon occurs.

To prevent the occurrence of abnormal combustion, it is possible to retard the ignition timing. However, by retarding the ignition timing, the output torque becomes smaller or the fuel consumption deteriorates. Further, by retarding the ignition timing, the temperature of the exhaust gas rises. For this reason, sometimes high quality materials became necessary for the components of the exhaust purification device or a device for cooling the exhaust gas became necessary. Furthermore, to lower the temperature of the exhaust gas, sometimes the air-fuel ratio when burning fuel in a combustion chamber is made less than the stoichiometric air-fuel ratio. That is, sometimes the air-fuel ratio at the time of combustion is made rich. However, when a three-way catalyst is arranged as the exhaust purification device, there was the problem that if the air-fuel ratio of the exhaust gas deviates from the stoichiometric air-fuel ratio, the purification ability ends up becoming smaller and the exhaust gas can no longer be sufficiently purified.

The present invention has as its object the provision of a combustion pressure control system of an internal combustion engine which suppresses the occurrence of abnormal combustion.

### Solution to Problem

The combustion pressure control system of the present invention is a combustion pressure control system of a spark ignition type of internal combustion engine which has a sub chamber which is communicated with a combustion chamber, which system is provided with a volume changing device which changes a volume of the sub chamber by a change of pressure of the combustion chamber serving as a driving source when the pressure of the combustion chamber reaches a control pressure. The control pressure is set in range of larger than a maximum pressure of the combustion chamber in the case of suspending the supply of fuel and less than the pressure at which abnormal combustion of the fuel occurs. The volume changing device is formed so that when the pressure of the combustion chamber reaches the control pressure during the period from a compression stroke to an expansion stroke of a combustion cycle, the volume of the sub chamber becomes larger and a rise of the pressure of the combustion chamber is suppressed.

In the above invention, preferably the system is provided with a control pressure changing device for changing the control pressure and an operating state detecting device for detecting an operating state of the internal combustion engine, and the control pressure changing device changes the control pressure based on the operating state of the internal combustion engine which was detected by the operating state detecting device.

In the above invention, preferably the operating state detecting device detects a speed of the internal combustion engine, and the control pressure changing device increases the control pressure the larger the speed which is detected.

In the above invention, preferably the system is provided with a control pressure changing device for changing the control pressure and a fuel property detecting device for detecting a property of the fuel, and the control pressure changing device changes the control pressure based on the property of the fuel which is detected by the fuel property detecting device.

In the above invention, preferably the system is a combustion pressure control system of an internal combustion engine which burns fuel which contains alcohol, the fuel property detecting device detects a concentration of alcohol which is contained in the fuel, and the control pressure changing device increases the control pressure the larger the concentration of alcohol which is detected.

In the above invention, preferably the system advances the ignition timing when an amount of fuel which is fed to the combustion chamber is larger than a predetermined feed judgment value or when a temperature of exhaust gas is higher than a predetermined temperature judgment value.

In the above invention, the volume changing device can include a tubular part which is communicated with the combustion chamber, a moving member which is arranged movably at the inside of the tubular part and which defines a space at the inside of the tubular part to form a sub chamber at the side facing the combustion chamber, and a biasing device which biases the moving member toward the combustion chamber so that the moving member start to move at the control pressure. By the moving member moving through the inside of the tubular part, the volume of the sub chamber can change.

In the above invention, preferably the system is provided with a control pressure changing device for changing the control pressure, the moving member includes a sub chamber-use piston which is arranged at the inside of the tubular part, and the control pressure changing device temporarily lowers the speed of movement of the sub chamber-use piston when the pressure of the combustion chamber falls and the sub chamber-use piston moves toward the combustion chamber side.

In the above invention, preferably the biasing device includes a gas chamber which is formed to use gas pressure to bias the moving member toward the combustion chamber side, the moving member includes a sub chamber-use piston which is arranged at the inside of the tubular part, a gas chamber-use piston which is arranged at the inside of the tubular part and which is fastened to the sub chamber-use piston through a connecting rod, and an intermediate piston which is arranged at the inside of the tubular part between the sub chamber-use piston and the gas chamber-use piston, a space sandwiched between the gas chamber-use piston and the intermediate piston is filled with oil, and the gas chamber-use piston, intermediate piston, and sub chamber-use piston move integrally through the inside of the tubular part.

In the above invention, preferably the volume changing device is provided with a partition part which is fastened to the tubular part and is arranged between the gas chamber-use piston and the intermediate piston, the partition part has arranged at it a first check valve through which oil flows when the volume of the sub chamber becomes large and a second check valve through which oil flows when the volume of the sub chamber becomes small, and the second check valve is formed to have a smaller maximum flow rate than the first check valve.

In the above invention, preferably a first sealing member is arranged between the sub chamber-use piston and the tubular part, a second sealing member is arranged between the intermediate piston and the tubular part, a movement region of the first sealing member in the inner surface of the tubular part is formed with grooves for storage of oil, and the second sealing member moves in the region outside of the movement region of the first sealing member.

In the above invention, preferably the system is a combustion pressure control system of an internal combustion engine which is provided with a plurality of combustion chambers and has a volume changing device arranged at each of the combustion chambers, the biasing device includes a gas chamber which is formed to use gas pressure to bias the moving member toward the combustion chamber side, and the plurality of gas chambers which are arranged for the combustion chambers are connected with each other.

In the above invention, preferably the biasing device includes a gas chamber which is formed to use gas pressure to bias the moving member toward the combustion chamber side and an auxiliary tank which is connected to the gas chamber.

In the above invention, preferably the system is provided with an auxiliary cylinder which includes an auxiliary chamber in which a gas is sealed and an auxiliary piston and is arranged in proximity to the sub chamber, the biasing device includes a gas chamber which is formed so as to bias the moving member toward the combustion chamber side, the tubular part is formed to be able to move so that the volume of the gas chamber changes and the system is formed so that a change of temperature of the auxiliary chamber of the auxiliary cylinder causes the auxiliary piston to move, the movement of the auxiliary piston is used to drive movement of the tubular part, and the volume of the gas chamber is thereby changed.

In the above invention, preferably the sub chamber is arranged separated from the combustion chamber, the volume changing device includes a connecting pipe which connects the combustion chamber and the sub chamber, and the connecting pipe is connected to the combustion chamber near an ignition device.

### ADVANTAGEOUS EFFECTS OF INVENTION

According to the present invention, it is possible to provide a combustion pressure control system of an internal combustion engine which suppresses the occurrence of abnormal combustion.

### BRIEF DESCRIPTION OF DRAWINGS

FIG. 1 is a schematic view of an internal combustion engine in an Embodiment 1.

FIG. 2 is a schematic view of a first combustion pressure control system in the Embodiment 1.

FIG. 3 is a view which explains a pressure of a combustion chamber and a displacement of a sub chamber-use piston in a first combustion pressure control system in the Embodiment 1.

FIG. 4 is a graph for explaining a relationship between an ignition timing and an output torque in a comparative example.

FIG. 5 is a graph for explaining a relationship between a crank angle and a pressure of a combustion chamber in the comparative example.

FIG. 6 is a graph for explaining a relationship between a load and a maximum pressure of a combustion chamber in the comparative example.

FIG. 7 is an enlarged view of a graph when a pressure of a combustion chamber reaches a control pressure in the Embodiment 1.

FIG. 8 is a graph for explaining an ignition timing of an internal combustion in the Embodiment 1 and an internal combustion engine of the comparative example.

FIG. 9 is a graph for explaining a relationship between an ignition timing of an internal combustion engine and a temperature of the exhaust gas and output torque in the Embodiment 1.

FIG. 10 is a schematic view of a second combustion pressure control system in the Embodiment 1.

FIG. 11 is a schematic view of a third combustion pressure control system in the Embodiment 1.

FIG. 12 is a schematic view of a fourth combustion pressure control system in the Embodiment 1.

FIG. 13 is a schematic view of a first combustion pressure control system in an Embodiment 2.

FIG. 14 is a graph for explaining a relationship between a speed of an internal combustion engine and a knocking safety margin ignition timing in the comparative example.

FIG. 15 is a graph for explaining a relationship between a speed of the internal combustion engine and a control pressure in the Embodiment 2.

FIG. 16 is a graph for explaining a relationship between a concentration of alcohol which is contained in fuel and an amount of correction by retardation in the comparative example.

FIG. 17 is a graph for explaining a relationship between a concentration of alcohol and a control pressure in the Embodiment 2.

FIG. 18 is a schematic view of a second combustion pressure control system in the Embodiment 2.

FIG. 19 is a time chart which explains an example of operation of a second combustion pressure control system in the Embodiment 2.

FIG. 20 is a schematic cross-sectional view of a first combustion pressure control system in an Embodiment 3.

FIG. 21 is a schematic cross-sectional view of a second combustion pressure control system in the Embodiment 3.

FIG. 22 is a schematic cross-sectional view of a third combustion pressure control system in the Embodiment 3.

FIG. 23 is a schematic cross-sectional view of a fourth combustion pressure control system in the Embodiment 3.

FIG. 24 is another schematic cross-sectional view of a fourth combustion pressure control system in the Embodiment 3.

FIG. 25 is a schematic cross-sectional view of a fifth combustion pressure control system in the Embodiment 3.

FIG. 26 is an enlarged schematic cross-sectional view of a partition part of a fifth combustion pressure control system in the Embodiment 3.

FIG. 27 is another schematic cross-sectional view of a fifth combustion pressure control system in the Embodiment 3.

FIG. 28 is a time chart for explaining an example of operation of a fifth combustion pressure control system in the Embodiment 3.

FIG. 29 is a schematic cross-sectional view of a first combustion pressure control system in an Embodiment 4.

FIG. 30 is a schematic cross-sectional view of a second combustion pressure control system in the Embodiment 4.

FIG. 31 is a graph for explaining a relationship between a displacement of a sub chamber-use piston and a pressure of a sub chamber of a second combustion pressure control system in the Embodiment 4.

FIG. 32 is a schematic cross-sectional view of a first combustion pressure control system in an Embodiment 5.

FIG. 33 is a schematic plan view which explains a connection position of a connecting pipe of a first combustion pressure control system in the Embodiment 5.

FIG. 34 is a schematic cross-sectional view of a second combustion pressure control system in the Embodiment 5.

FIG. 35 is a time chart which explains an example of operation of a second combustion pressure control system in the Embodiment 5.

FIG. 36 is a schematic view of a third combustion pressure control system in the Embodiment 5.

FIG. 37 is a time chart which explains an example of operation of a third combustion pressure control system in the Embodiment 5.

FIG. 38 is a time chart which explains another example of operation of a third combustion pressure control system in the Embodiment 5.

FIG. 39 is a schematic plan view which explains a connection position of a connecting pipe of a fourth combustion pressure control system in the Embodiment 5.

FIG. 40 is a schematic cross-sectional view of a fifth combustion pressure control system in the Embodiment 5.

### DESCRIPTION OF EMBODIMENTS

### Embodiment 1

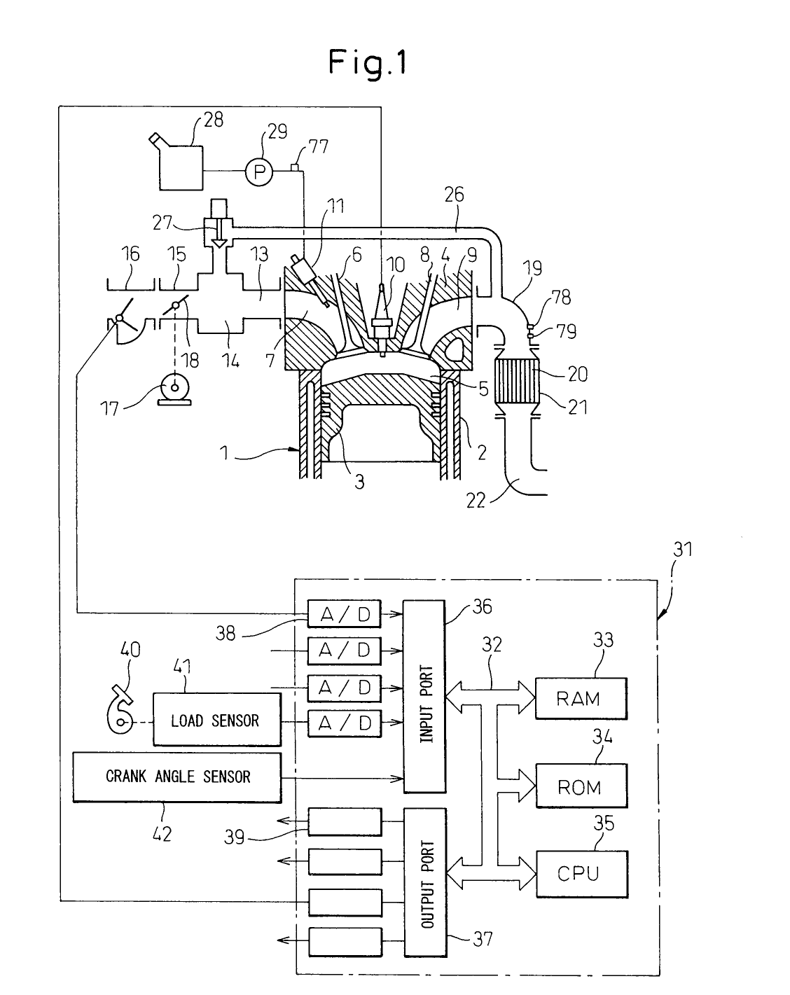

Referring to FIG. 1 to FIG. 12, a combustion pressure control system of the internal combustion engine in an Embodiment 1 will be explained. In the present embodiment, an internal combustion engine which is arranged in a vehicle will be explained as an example.

FIG. 1 is a schematic view of an internal combustion engine in the present embodiment. FIG. 1 is a schematic cross-sectional view when a combustion chamber is cut in a direction in which the intake valves and exhaust valves are arranged. The internal combustion engine in the present embodiment is a spark ignition type. The internal combustion engine is provided with an engine body 1. The engine body 1 includes a cylinder block 2 and a cylinder head 4. Inside of the cylinder block 2, combustion chambers of the cylinders are formed. In each combustion chamber 5, a piston 3 is arranged. Each combustion chamber 5 is connected to an engine intake passage and an engine exhaust passage. The engine intake passage is a passage for supplying the combustion chambers 5 with air or a mixture of fuel and air. The engine exhaust passage is a passage for discharging exhaust gas which is produced due to burning of fuel in the combustion chambers 5.

The cylinder head 4 is formed with intake ports 7 and exhaust ports 9. An intake valve 6 is arranged at the end of each intake port 7, whereby the engine intake passage which is communicated with the combustion chambers 5 can be opened and closed. An exhaust valve 8 is arranged at the end of each exhaust port 9, whereby the engine exhaust passage which is communicated with the combustion chambers 5 can be opened and closed. The cylinder head 4 has spark plugs 10 fastened to it as ignition devices. Each spark plug 10 is formed so as to ignite the fuel in a combustion chamber 5.

The internal combustion engine in the present embodiment is provided with fuel injectors 11 for supplying the combustion chambers 5 with fuel. Each fuel injector 11 in the present embodiment is arranged to inject fuel to an intake port 7. The fuel injectors 11 are not limited to this and need only be arranged so as to supply fuel to the combustion chambers 5. For example, the fuel injectors may also be arranged so as to directly inject fuel to the combustion chambers.

Each fuel injector 11 is connected through an electronically controlled type of variable discharge fuel pump 29 to a fuel tank 28. Fuel which is stored inside the fuel tank 28 is fed by the fuel pump 29 to the fuel injector 11. In the middle of the flow path of feed of fuel, as a fuel property detecting device for detecting a property of the fuel, a fuel property sensor 77 is arranged. For example, in an internal combustion engine which uses fuel containing alcohol, as the fuel property sensor 77, an alcohol concentration sensor is arranged. The fuel property detecting device may also be arranged at the fuel tank.

The intake port 7 of each cylinder is connected through a corresponding intake runner 13 to a surge tank 14. The surge tank 14 is connected through an intake duct 15 and an air flow meter 16 to an air cleaner (not shown). At the intake duct 15, an air flow meter 15 which detects the intake air amount is arranged. Inside of the intake duct 15, a throttle valve 18 which is driven by a step motor 17 is arranged. On the other hand, the exhaust port 9 of each cylinder is connected to a corresponding exhaust runner 19. The exhaust runner 19 is connected to a catalytic converter 21. The catalytic converter 21 in the present embodiment includes a three-way catalyst 20. The catalytic converter 21 is connected to an exhaust pipe 22. At the engine exhaust passage, a temperature sensor 78 for detecting a temperature of the exhaust gas is arranged.

The engine body in the present embodiment has a recirculation passage for exhaust gas recirculation (EGR). In the present embodiment, as the recirculation passage, an EGR gas conduit 26 is arranged. The EGR gas conduit 26 connects the exhaust runners 19 and the surge tank 14. In the EGR gas conduit 26, an EGR control valve 27 is arranged. The EGR control valve 27 is formed to enable adjustment of the flow rate of the exhaust gas being recirculated. If referring to the ratio of the air and fuel (hydrocarbons) in the exhaust gas which is fed to the engine intake passage, the combustion chambers, or the engine exhaust passage as the air-fuel ratio (A/F) of the exhaust gas, an air-fuel ratio sensor 79 for detecting the air-fuel ratio of the exhaust gas is arranged inside the engine exhaust passage at the upstream side of the catalytic converter 21.

The internal combustion engine in the present embodiment is provided with an electronic control unit 31. The electronic control unit 31 in the present embodiment is comprised of a digital computer. The electronic control unit 31 includes components which are connected to each other through a bidirectional bus 32 such as a RAM (random access memory) 33, ROM (read only memory) 34, CPU (microprocessor) 35, input port 36, and output port 37.

The air flow meter 16 generates an output voltage which is proportional to the amount of intake air which is taken into the combustion chambers 5. The output voltage is input through a corresponding AD converter 38 to the input port 36. The accelerator pedal 40 is connected to a load sensor 41. The load sensor 41 generates an output voltage which is proportional to an amount of depression of the accelerator pedal 40. This output voltage is input through a corresponding AD converter 38 to the input port 36. Further, a crank angle sensor 42 generates an output pulse every time a crankshaft, for example, rotates 30°. This output pulse is input to the input port 36. From the output of the crank angle sensor 42, it is possible to detect the speed of the engine body 1. Furthermore, the electronic control unit 31 receives as input signals of the fuel property sensor 77, temperature sensor 78, air-fuel ratio sensor 79, and other sensors.

The output port 37 of the electronic control unit 31 is connected through corresponding drive circuits 39 to the fuel injectors 11 and the spark plugs 10. The electronic control unit 31 in the present embodiment is formed so as to control the fuel injection and to control the ignition. That is, the timing of injection of fuel and the amount of injection of fuel are controlled by the electronic control unit 31. Furthermore, the ignition timing of a spark plug 10 is controlled by the electronic control unit 31. Further, the output port 37 is connected through corresponding drive circuits 39 to a step motor 17 which drives the throttle valve 18, the fuel pump 29, and the EGR control valve 27. These devices are controlled by the electronic control unit 31.

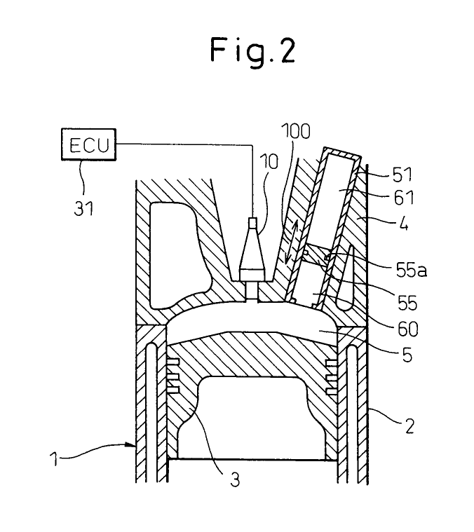

FIG. 2 is a schematic view of a first combustion pressure control system in the present embodiment. FIG. 2 is a schematic cross-sectional view when the combustion chamber is cut in a direction different from the direction in which the intake valves and exhaust valves are arranged.

The internal combustion engine in the present embodiment is provided with a combustion pressure control system which controls the pressure of the combustion chambers when the fuel is burned. The internal combustion engine in the present embodiment is provided with a sub chamber 60 which is communicated with each combustion chamber 5. The combustion pressure control system is provided with a volume changing device which changes a volume of the sub chamber by a change of pressure of the combustion chamber serving as a driving source when the pressure of the combustion chamber 5 reaches a control pressure. That is, the volume changing device operates due to a change of the pressure of a combustion chamber 5. The “control pressure” in the present invention is the pressure when the volume of a sub chamber which is communicated with a combustion chamber starts to change. The volume changing device performs control so that the pressure of the combustion chamber 5 does not become equal to or more than a pressure at which abnormal combustion occurs.

“Abnormal combustion” in the present invention indicates combustion other than a state where an ignition device ignites the air-fuel mixture and combustion is successively propagated from the ignited point. Abnormal combustion includes, for example, the knocking phenomenon, detonation phenomenon, and preignition phenomenon. The knocking phenomenon includes the spark knock phenomenon. The spark knock phenomenon is the phenomenon where when the ignition device ignites the air-fuel mixture and the flame spreads centered from the ignition device, the air-fuel mixture including unburned fuel which is at a position far from the ignition device self ignites. The air-fuel mixture at a position far from the ignition device is compressed by the combustion gas near the ignition device so becomes a high temperature and high pressure and self ignites. When the air-fuel mixture self ignites, a shock wave is produced.

The detonation phenomenon is the phenomenon where the air-fuel mixture ignites due to passage of a shock wave through a high temperature, high pressure air-fuel mixture. This shock wave is, for example, generated due to the spark knock phenomenon.

The preignition phenomenon is also called the “early ignition phenomenon”. The preignition phenomenon is a phenomenon where the metal at the tip of a spark plug or carbon sludge which is deposited in a combustion chamber etc. is heated and maintained at a predetermined temperature or more and, in that state, this part becomes the spark for ignition and burning of fuel before the ignition timing.

The volume changing device is provided with a tubular member 51 which forms a tubular part which is communicated with a combustion chamber 5. The tubular member 51 in the present embodiment is formed in a cylindrical shape. At the inside of the tubular member 51, a moving member including a sub chamber-use piston 55 is arranged. The space at the inside of the tubular member 51 is divided by the sub chamber-use piston 55. At the inside of the tubular member 51, a sub chamber 60 is formed at the side facing the combustion chamber 5, while a gas chamber 61 is formed at the opposite side to the side facing the combustion chamber 5.

The gas chamber 61 of the first combustion pressure control system in the present embodiment is sealed. The gas chamber 61 has a gas sealed inside of it. In the present embodiment, the gas chamber 61 has nitrogen sealed inside it. The gas which is filled in the gas chamber 61 is not limited to nitrogen. Any gas may be employed.

The sub chamber-use piston 55, as shown by the arrow 100, is arranged so as to be able to move inside of the tubular member 51. The sub chamber-use piston 55 contacts the tubular member 51 through a piston ring 55a. The combustion gas flows into the sub chamber 60. As the sealing member of the chamber-use piston 55, a piston ring 55a which has heat resistance is arranged. The piston ring 55a is, for example, formed by a metal. The sub chamber-use piston 55 is not fastened to the tubular member 51, but is formed to move in the axial direction of the tubular member 51.

The volume changing device includes a biasing device which biases the sub chamber-use piston 55 toward the combustion chamber 5 so that the sub chamber-use piston 55 starts to move at the control pressure. In the present embodiment, the pressure of the sealed gas chamber 61 is used to bias the sub chamber-use piston 55. The gas chamber 61 has a gas sealed inside it so that when the sub chamber-use piston 55 is seated at the bottom of the tubular member 51, the gas pressure becomes the control pressure.

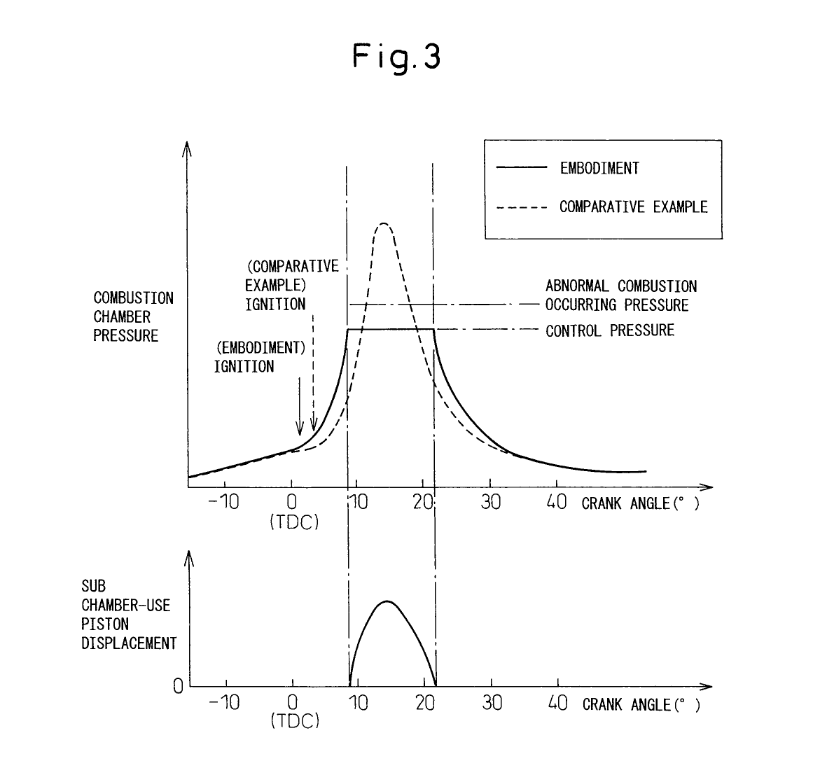

FIG. 3 is a graph of the pressure of a combustion chamber in the internal combustion engine of the present embodiment. The abscissa indicates the crank angle, while the ordinate indicates the pressure of the combustion chamber and the displacement of the sub chamber-use piston. FIG. 3 is a graph of the compression stroke and the expansion stroke in the combustion cycle. The sub chamber-use piston 55 has a displacement of zero when seated at the bottom of the tubular member 51. In the volume changing device in the present embodiment, when the pressure of the combustion chamber 5 reaches the control pressure in the period from the compression stroke to the expansion stroke of the combustion cycle, the sub chamber-use piston 55 moves driven by the change in pressure of the combustion chamber 5. As a result, the volume of the sub chamber 60 becomes larger.

Referring to FIG. 2 and FIG. 3, at the time of start of the compression stroke, the sub chamber-use piston 55 is arranged at the bottom of the tubular member 51. In the compression stroke, the piston 3 rises and the pressure of the combustion chamber 5 rises. Here, since the gas chamber 61 has gas of the control pressure sealed inside it, the sub chamber-use piston 55 is maintained in a seated state until the pressure of the combustion chamber 5 becomes the control pressure.

In the example shown in FIG. 3, the air-fuel mixture is ignited when the crank angle is slightly after 0° (TDC). Due to its being ignited, the pressure of the combustion chamber 5 sharply rises. When the pressure of the combustion chamber 5 reaches the control pressure, the sub chamber-use piston 55 starts to move. As the combustion of the air-fuel mixture advances, the gas in the gas chamber 61 is compressed and thereby the displacement of the sub chamber-use piston 55 becomes greater. For this reason, the rise of the pressures of the combustion chamber 5 and sub chamber 60 is suppressed. In the example shown in FIG. 3, the pressure of the combustion chamber 5 is held substantially constant.

In the combustion chamber 5, when the fuel further continues to burn, the displacement of the sub chamber-use piston 55 becomes maximum, then becomes smaller. The pressure of the gas chamber 61 decreases toward the control pressure. When the pressure of the combustion chamber 5 becomes the control pressure, the displacement of the sub chamber-use piston 55 returns to zero. That is, the sub chamber-use piston 55 returns to the seated position. When the pressure of the combustion chamber 5 becomes less than the control pressure, the pressure of the combustion chamber 5 is reduced along with the advance of the crank angle.

In this way, the combustion pressure control system in the present embodiment performs control to suppress the rise of the pressure of a combustion chamber when the pressure of the combustion chamber 5 reaches the control pressure and to prevent the pressure of the combustion chamber from becoming a pressure where abnormal combustion occurs or more.

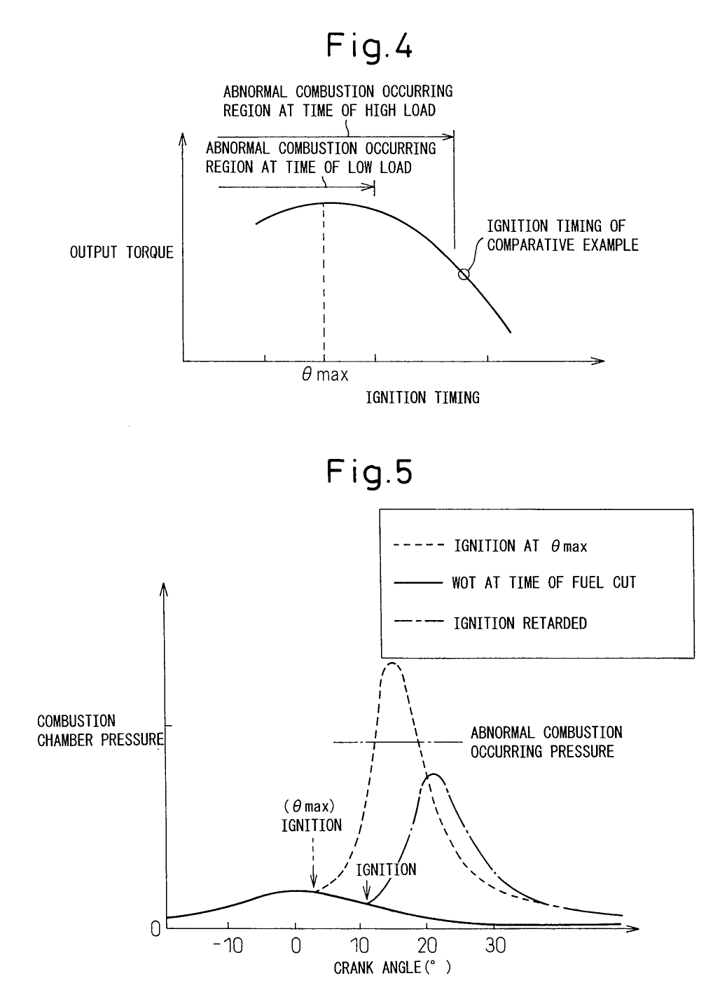

FIG. 4 is a graph which explains the relationship between an ignition timing and an output torque in an internal combustion engine of a comparative example. The internal combustion engine of the comparative example does not have a sub chamber. That is, the comparative example is an internal combustion engine which does not have a volume changing device. The graph of FIG. 4 is a graph when operating the internal combustion engine of the comparative example in a predetermined state. The abscissa indicates the crank angle at the time of ignition (ignition timing).

It will be understood that the performance of the internal combustion engine changes by the timing at which the air-fuel mixture is ignited. The internal combustion engine has an ignition timing (Omax) at which the output torque becomes maximum. The ignition timing at which the output torque becomes maximum changes depending on the engine speed, throttle opening degree, air-fuel ratio, compression ratio, etc. By ignition at the ignition timing at which the output torque becomes maximum, the pressure of a combustion chamber becomes higher and the heat efficiency becomes the best. For this reason, the output torque becomes larger and the amount of fuel consumption can be reduced. Further, the carbon dioxide which is exhausted can be reduced.

In this regard, if advancing the ignition timing, the knocking phenomenon and other abnormal combustion occur. In particular, when becoming a high load, the region in which abnormal combustion occurs becomes larger. In the internal combustion engine of the comparative example, to avoid abnormal combustion, the air-fuel mixture is ignited retarded from the ignition timing at which the output torque becomes maximum. In this way, an ignition timing avoiding the region at which abnormal combustion occurs is selected.

FIG. 5 shows a graph of a pressure of a combustion chamber of the internal combustion engine of the comparative example. The solid line shows the pressure of the combustion chamber when the feed of fuel is stopped (fuel cut) and the opening degree of the throttle valve is wide open (WOT). The pressure of the combustion chamber at this time becomes maximum when the crank angle is 0°, that is, at compression top dead center. This pressure becomes the maximum pressure of the combustion chamber when fuel is not fed.

In the internal combustion engine, the pressure of the combustion chamber fluctuates depending on the ignition timing. The curve shown by the broken line is the curve at the time of ignition at the ignition timing where the output torque becomes maximum. The broken line shows the curve when assuming no abnormal combustion occurs. In the example which is shown in FIG. 5, the air-fuel mixture is ignited at a timing when the crank angle is slightly after 0° (TDC). When the air-fuel mixture is ignited at the ignition timing where the output torque becomes maximum, the pressure of the combustion chamber becomes high. However, in an actual internal combustion engine, the maximum pressure of the combustion chamber (Pmax) is greater than the pressure at which abnormal combustion occurs, so the ignition timing is retarded. The one-dot chain line is the curve for which the ignition timing is retarded. When retarding the ignition timing, the maximum pressure of the combustion chamber becomes smaller than when the air-fuel mixture is ignited at an ignition timing where the output torque becomes maximum.

Referring to FIG. 3, the broken line shows the curve in the case when the air-fuel mixture is ignited at the ignition timing θmax where the output torque becomes maximum in the internal combustion engine of the comparative example. As explained above, when the air-fuel mixture is ignited at this ignition timing, abnormal combustion occurs.

As opposed to this, the internal combustion engine in the present embodiment can burn an air-fuel mixture in the state where the pressure of the combustion chamber is less than the pressure where abnormal combustion occurs. Even if advancing the ignition timing, the occurrence of abnormal combustion can be suppressed. In particular, even in an engine with a high compression ratio, the abnormal combustion can be suppressed. For this reason, compared with the internal combustion engine of the comparative example retarded in ignition timing shown in FIG. 5, the heat efficiency is improved and the output torque can be increased. Alternatively, the amount of fuel consumption can be reduced.

In the internal combustion engine of the present embodiment, the air-fuel mixture is ignited at the ignition timing at which the heat efficiency becomes the best. The internal combustion engine in the present embodiment can ignite the air-fuel mixture at the ignition timing at which the output torque of the internal combustion engine of the comparative example shown in FIG. 3 becomes maximum. However, the internal combustion engine in the present embodiment advances the ignition timing from the ignition timing at which the output torque of the internal combustion engine of the comparative example becomes maximum. Due to this configuration, the heat efficiency can be improved more and, furthermore, the output torque can be increased. In this way, the internal combustion engine in the present embodiment can ignite the air-fuel mixture at the timing at which the heat efficiency becomes the best while avoiding abnormal combustion.

In the present embodiment, the gas pressure of the gas chamber 61 when the sub chamber-use piston 55 is seated at the bottom of the tubular member 51 becomes the control pressure. The control pressure may be made larger than the maximum pressure of the combustion chamber in the case of stopping the feed of fuel. That is, it may be set larger than the maximum pressure of the combustion chamber of the curve of the solid line shown in FIG. 5. Further, the control pressure can be set the less than the pressure at which abnormal combustion occurs.

In the internal combustion engine of the comparative example, the temperature of the exhaust gas becomes higher due to the retardation of the ignition timing. Alternatively, the temperature of the exhaust gas becomes higher since the heat efficiency is low. In the internal combustion engine of the comparative example, to lower the temperature of the exhaust gas, it is possible to make the air-fuel ratio at the time of combustion smaller than the stoichiometric air-fuel ratio. In this regard, the exhaust purification device comprised of the three-way catalyst has a high purification ability when the air-fuel ratio of the exhaust gas is near the stoichiometric air-fuel ratio. The three-way catalyst ends up with an extremely small purification ability when the ratio deviates from the stoichiometric air-fuel ratio. For this reason, if the air-fuel ratio at the time of combustion becomes smaller than the stoichiometric air-fuel ratio, the purification ability of the exhaust gas ends up falling and the amount of unburned fuel which is contained in the exhaust gas ends up becoming greater. Further, in the internal combustion engine of the comparative example, the temperature of the exhaust gas becomes high, so heat resistance of the exhaust purification device is sought and a high quality material becomes required or a device for cooling the exhaust gas or a new structure for cooling the exhaust gas becomes required in some cases.

As opposed to this, in the internal combustion engine in the present embodiment, the heat efficiency is high, so it is possible to avoid the temperature of the exhaust gas becoming higher. In the internal combustion engine in the present embodiment, there is little need to reduce the air-fuel ratio at the time of combustion so as to lower the temperature of the exhaust gas and the purification performance of the exhaust purification device when containing a three-way catalyst can be maintained. Furthermore, since it is possible to avoid the temperature of the exhaust gas becoming high, the demand for heat resistance of the members of the exhaust purification device becomes low. Alternatively, it is possible to form the system even without newly adding a device for cooling the exhaust gas etc.

Further, referring to FIG. 3, in general, when raising the compression ratio of the internal combustion engine so as to improve the heat efficiency, the maximum pressure Pmax of a combustion chamber becomes larger. For this reason, it is necessary to increase the strength of the members forming the internal combustion engine. However, in the internal combustion engine in the present embodiment, it is possible to avoid the maximum pressure of the combustion chamber becoming larger and possible to avoid the component members becoming larger. For example, it is possible to avoid the diameter of the connecting rod become larger. Further, it is possible to avoid the friction between component members becoming larger and possible to suppress deterioration of the fuel consumption rate.

Furthermore, when the maximum pressure of a combustion chamber is high, there is the problem that it is difficult to increase the size of the combustion chamber. If the size of the combustion chamber becomes large, it is necessary to increase the strength of the supporting parts of the piston and other component members. It is therefore necessary to increase the strength of the component members. However, in the present embodiment, the maximum pressure of a combustion chamber can be maintained low, so it is possible to keep the required strength of the component members low. For this reason, it is possible to easily increase the size of a combustion chamber.

Next, the control pressure in the combustion pressure control system of an internal combustion engine of the present embodiment will be explained.

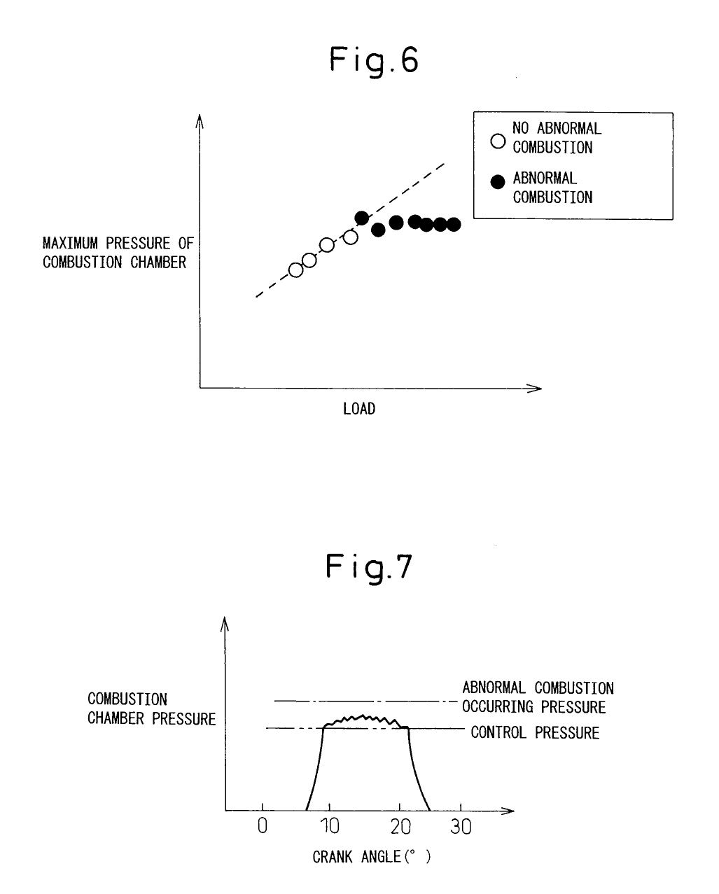

FIG. 6 is a graph showing the relationship between the load of the internal combustion engine and the maximum pressure of a combustion chamber in the comparative example. The load of the internal combustion engine corresponds to the amount of injection of fuel in a combustion chamber. When abnormal combustion does not occur, as shown by the broken line, the maximum pressure of a combustion chamber increases along with an increase in the load. When becoming larger than the predetermined pressure, abnormal combustion occurs. It is learned that the maximum pressure of a combustion chamber when abnormal combustion occurs is substantially constant regardless of the load.

In the internal combustion engine in the present embodiment, the control pressure is set so that the pressure of a combustion chamber does not reach the pressure at which abnormal combustion occurs. As the control pressure, a large pressure is preferable within a range where the maximum pressure of a combustion chamber when the fuel burns becomes smaller than the pressure at which abnormal combustion occurs. It is preferable to increase the control pressure to near the pressure at which abnormal combustion occurs. Due to this configuration, it is possible to suppress abnormal combustion while increasing the heat efficiency.

FIG. 7 shows another graph of the pressure of a combustion chamber in the internal combustion engine in the present embodiment. Referring to FIG. 2 and FIG. 7, in the internal combustion engine of the present embodiment, the sub chamber-use piston 55 moves by the control pressure being reached. At this time, the pressure at the inside of the gas chamber 61 rises. In particular, when the volume of the gas chamber 61 is small, the pressure of the gas chamber 61 rises. For this reason, the pressure at the inside of the combustion chamber 5 sometimes rises along with the rise of the pressure of the gas chamber 61. The curve of the pressure of the combustion chamber 5 becomes an upwardly bulging shape when larger than the control pressure. For this reason, when determining the control pressure, it is preferable to set it low, anticipating a rise of the pressure of the gas chamber 61, so that the pressure of the combustion chamber does not reach a pressure where abnormal combustion occurs.

Furthermore, sometimes the moving member, including the sub chamber-use piston 55, does not move smoothly and the pressure bounces back. As shown in FIG. 7, sometimes the pressure of the combustion chamber pulsates. For this reason, the control pressure is preferably set low considering pulsation of the pressure of the combustion chamber. In this way, the control pressure is preferably set to the pressure at which abnormal combustion occurs minus a predetermined pressure.

Next, the ignition timing in the combustion pressure control system of the internal combustion engine of the present embodiment will be explained.

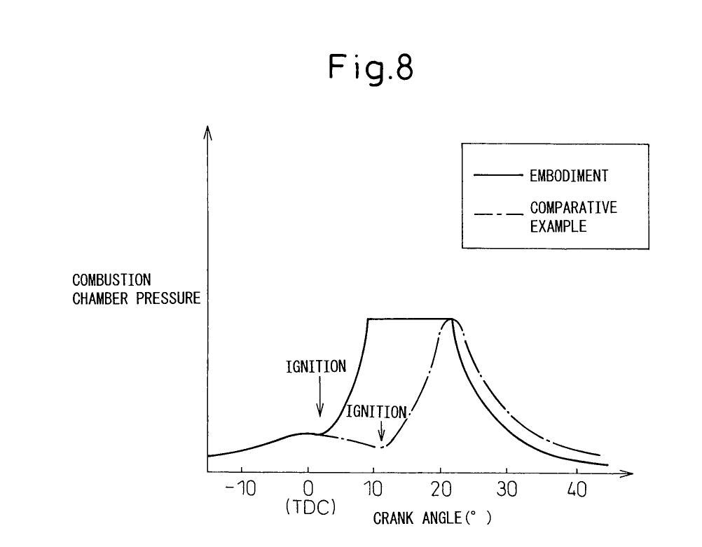

FIG. 8 shows a graph of the pressure of a combustion chamber in the present embodiment and the comparative example. The solid line shows the curve when the air-fuel mixture is ignited at the timing when the output torque becomes maximum in an internal combustion engine of the present embodiment. The one-dot chain line shows the curve when retarding the ignition timing in an internal combustion engine of the comparative example.

In the internal combustion engine in the present embodiment, as explained above, preferably the ignition timing θmax at which the heat efficiency of the internal combustion engine becomes maximum is selected. However, the pressure of a combustion chamber becomes higher at this ignition timing. For example, the pressure of a combustion chamber at the ignition timing of the present embodiment becomes larger than the pressure of a combustion chamber at the ignition timing of the comparative example. For this reason, depending on the internal combustion engine, sometimes a spark will not fly and misfire will end up occurring. In particular, in the internal combustion engine of the present embodiment, ignition is performed when the crank angle is near 0°(TDC). When the crank angle is near 0°, the pressure of a combustion chamber is high, so in this state, sparks will have a hard time flying. That is, the air density is high, so in this state electrodischarge becomes hard.

Referring to FIG. 1, if misfire occurs in a combustion chamber 5, the unburned fuel will pass through the engine exhaust passage and flow into the exhaust purification device. In the present embodiment, the unburned fuel will pass through the exhaust port 9 and flow into the three-way catalyst 20. In this case, sometimes the unburned fuel which flows into the three-way catalyst 20 will become greater and the properties of the exhaust gas which is discharged into the atmosphere will deteriorate. Alternatively, sometimes the unburned fuel will burn in the three-way catalyst 20 and the three-way catalyst 20 will become overheated.

Referring to FIG. 8, in an internal combustion engine where such misfire is liable to occur, the ignition timing may be advanced. That is, it is possible to make the ignition timing earlier. For example, it is possible to advance the ignition timing beyond the ignition timing at which the output torque becomes maximum. By making the ignition timing earlier, it is possible to ignite the air-fuel mixture when the pressure of a combustion chamber is low and therefore suppress misfire.

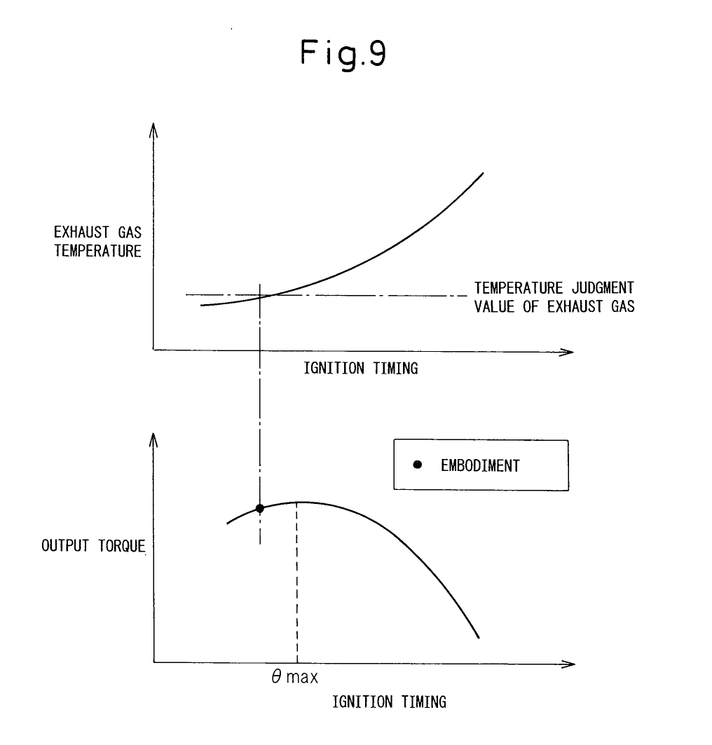

FIG. 9 shows a graph which explains the output torque and the temperature of the exhaust gas in an internal combustion engine in the present embodiment. It is learned that by making the ignition timing in a combustion chamber earlier, the temperature of the exhaust gas which is exhausted from the combustion chamber falls.

For example, sometimes the temperature judgment value of the exhaust gas is determined in advance to secure heat resistance of the parts forming the exhaust purification device. Referring to FIG. 1, it is possible to use the temperature sensor 78 to detect the temperature of the exhaust gas and, when the temperature of the exhaust gas exceeds a predetermined temperature judgment value, advance the ignition timing. Furthermore, if the amount of injection of fuel which is fed into a combustion chamber 5 increases, the temperature of the exhaust gas rises. For this reason, when the amount of feed of fuel from the fuel injector 11 becomes larger than a predetermined feed judgment value, the ignition timing can be advanced. Due to this configuration, it is possible to make the temperature of the exhaust gas which is exhausted from a combustion chamber 5 drop. It is possible to keep the exhaust purification device from becoming overheated. Alternatively, by performing control to ignite the air-fuel mixture at an advanced ignition timing, it is possible to lower the required heat resistance of the parts forming the exhaust purification device. For example, it is possible to form the exhaust purification device without using high quality materials.

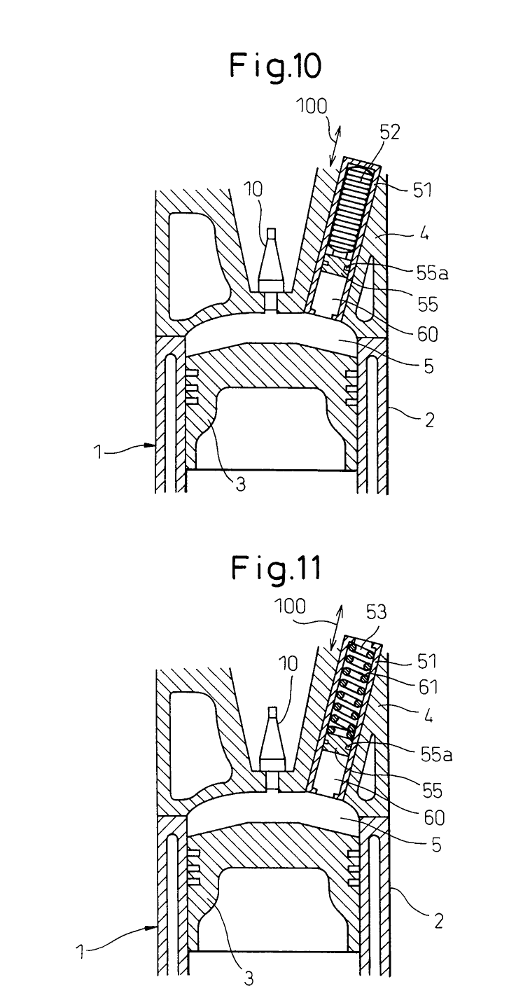

FIG. 10 is a schematic cross-sectional view of a second combustion pressure control system in the present embodiment. In the second combustion pressure control system, at the inside of the tubular member 51, a deformable container is arranged in the space at the opposite side from the combustion chamber 5 across the sub chamber-use piston 55. The deformable container in the present embodiment includes a bellows 52. The inside of the bellows 52 is filled with a gas whereby a gas chamber is formed. By arranging a bellows 52 and filling the inside with a gas in this way, it is possible to keep gas from leaking from the gas chamber. For example, it is possible to keep gas from leaking out through the seal part of the piston ring 55a.

FIG. 11 is a schematic cross-sectional view of a third combustion pressure control system in the present embodiment. In the third combustion pressure control system, a mechanical spring is arranged as a biasing device which biases the sub chamber-use piston 55. The spring in the present embodiment includes a coil spring 53. The coil spring 53 is arranged at the inside of the tubular member 51. In this way, the biasing device is not limited to a gas chamber. It is possible to employ any device which can bias the sub chamber-use piston.

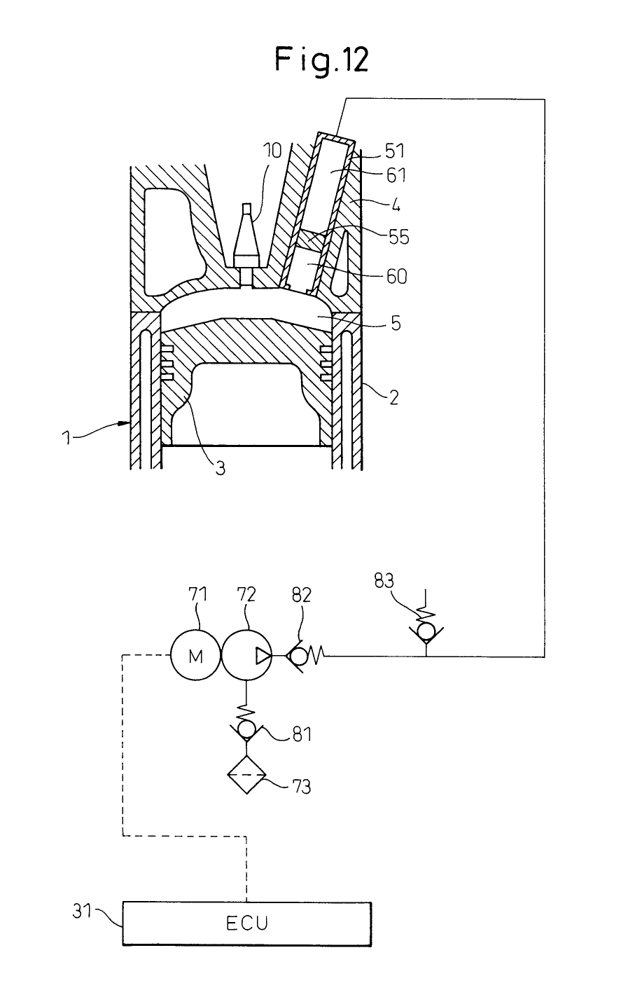

FIG. 12 is a schematic view of a fourth combustion pressure control system in the present embodiment. The fourth combustion pressure control system is provided with a gas feed device for feeding a gas to the gas chamber 61 of the tubular member 51. In the fourth combustion pressure control system, the gas chamber 61 is filled with air.

The gas feed device in the present embodiment includes a motor 71 and a compressor 72 which is driven by the motor 71. The gas chamber 61 is connected through a check valve 82 to the compressor 72. The check valve 82 prevents the gas of the gas chamber 61 from flowing back and out. In the middle of the flow path which connects the compressor 72 and the gas chamber 61, a branched flow path is formed. In this branched flow path, a check valve 83 is arranged. The check valve 83 is formed to open by a pressure larger than the control pressure at which the sub chamber-use piston 55 starts to move. By arranging the check valve 83, it is possible to avoid the pressure at the inside of the gas chamber 61 becoming larger than the control pressure.

The compressor 72 has a check valve 81 and a filter 73 connected to it. The filter 73 removes foreign objects from the air which is sucked into the compressor 72. The check valve 81 prevents air from flowing back from the compressor 72.

The gas feed device is controlled by the electronic control unit 31. In the present embodiment, the motor 71 is controlled by the electronic control unit 31. The gas feed device, for example, is started up every predetermined interval and makes up for the gas which flowed out from the gas chamber 61.

By providing the gas feed device which feeds gas to the gas chamber in this way, even if gas leaks out from the gas chamber, it is possible to maintain the pressure at the inside of the gas chamber substantially constant. The gas feed device is not limited to this mode. It is possible to employ any device which can feed gas to the gas chamber.

Further, the combustion pressure control system of the internal combustion engine in the present embodiment can be provided with a pressure detecting device which detects the pressure of a combustion chamber. The pressure detecting device includes, for example, a cylinder pressure sensor (CPS). The cylinder pressure sensor detects the pressure at the combustion chamber. The cylinder pressure sensor, for example, is fastened to the cylinder head so that the pressure of the combustion chamber can be detected.

By arranging the cylinder pressure sensor, it is possible to detect when the moving member sticks to the tubular member. For example, when detecting the pressure when the fuel is burning and the pressure of the combustion chamber becomes larger than a predetermined judgment value, it can be judged that the moving member has stuck to the tubular member. For this judgment value, for example, it is possible to employ a pressure larger than the control pressure. Further, by arranging the cylinder pressure sensor, it is possible to detect when gas in the gas chamber has leaked out. For example, when the pressure in the combustion chamber does not reach the control pressure, it is possible to judge that gas which was filled in the gas chamber has leaked out.

In the present embodiment, by having the tubular member arranged adjacent to the combustion chamber, a sub chamber is formed, but the sub chamber-forming member which forms the sub chamber is not limited to this. For example, a sub chamber may also be formed by forming a hole in the cylinder head.

The volume changing device in the present embodiment is provided with a tubular member and a sub chamber-use piston which is arranged at the inside of the tubular member, but the invention is not limited to this. The volume changing device need only be formed so that the volume of the sub chamber changes driven by the change of the pressure of the combustion chamber. For example, it may also be formed by using an expandable and contractable container which has elasticity so as to form the sub chamber and by having the container itself deform so that the volume of the sub chamber changes.

### Embodiment 2

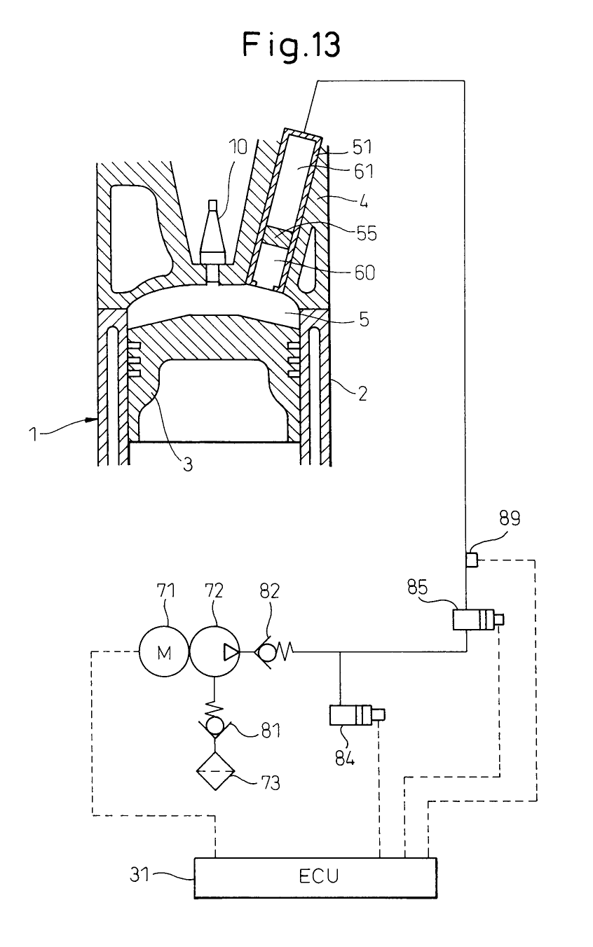

Referring to FIG. 13 to FIG. 19, a combustion pressure control system in an Embodiment 2 will be explained. The combustion pressure control system in the present embodiment is provided with a control pressure changing device for changing the control pressure. The combustion pressure control system in the present embodiment is provided with a gas feed device which feeds gas to the gas chamber. The gas feed device in the present embodiment functions as a control pressure changing device.

FIG. 13 is a schematic view of a first combustion pressure control system in the present embodiment. The volume changing device of the first combustion pressure control system is provided with a tubular member 51 and a sub chamber-use piston 55 which is arranged at the inside of the tubular member 51. At the inside of the tubular member 51, the sub chamber 60 and the gas chamber 61 are formed. The gas feed device in the present embodiment is provided with a motor 71, a compressor 72, check valves 81 and 82, and a filter 73 in the same way as the gas feed device in the Embodiment 1 (see FIG. 12). The gas feed device is controlled by an electronic control unit 31 also in the same way as the combustion pressure control system of the Embodiment 1.

The gas feed device in the present embodiment has the function of changing the pressure of the gas chamber 61. The gas feed device includes an exhaust valve 84. The exhaust valve 84 is arranged so as to be able to exhaust the gas. The exhaust valve 84 in the present embodiment is arranged in a flow path which is branched from the flow path which connects the compressor 72 and the gas chamber 61. The gas feed device includes a pressure regulator 85. The pressure regulator 85 is arranged in the flow path which connects the compressor 72 and the gas chamber 61. The pressure regulator 85 operates to regulate the pressure of the gas chamber 61. The exhaust valve 84 and the pressure regulator 85 in the present embodiment are solenoid valves and are controlled by the electronic control unit 31.

Further, the gas feed device in the present embodiment includes a pressure sensor 89. The pressure sensor 89 is arranged so as to detect the gas pressure of the gas chamber 61. The pressure sensor 89 in the present embodiment is arranged in the flow path which connects the compressor 72 and the gas chamber 61. The output value of the pressure sensor 89 is input to the electronic control unit 31.

The first combustion pressure control system in the present embodiment is provided with an operating state detecting device which detects an operating state of the internal combustion engine. It uses the detected operating state of the internal combustion engine as the basis to change the control pressure. It changes the pressure of the gas chamber 61 based on the operating state at any time period. By opening the pressure regulator 85 in the state where the compressor 72 is being driven, it is possible to make the pressure of the gas chamber 61 rise. By opening the pressure regulator 85 and the exhaust valve 84 in the state where the compressor 72 is stopped, it is possible to make the pressure of the gas chamber 61 fall. By changing the gas pressure of the gas chamber 61, it is possible to change the control pressure. For example, by raising the gas pressure of the gas chamber 61, it is possible to raise the control pressure.

Next, the operating state of the internal combustion engine for changing the control pressure will be explained with reference to the example of the engine speed. The operating state detecting device includes a crank angle sensor 42 for detecting the engine speed.

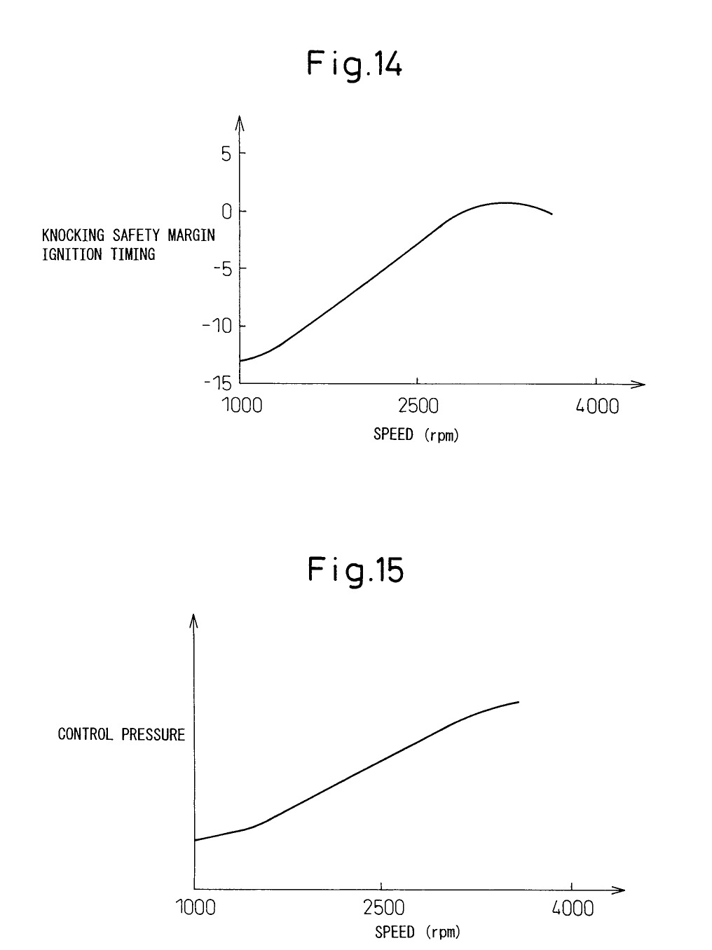

FIG. 14 shows a graph which explains the relationship between the speed of the internal combustion engine and the knocking safety margin ignition timing in the comparative example. The knocking safety margin ignition timing can be expressed by the following formula.

(Knocking safety margin ignition timing)=(Ignition timing at which knocking occurs)−(Ignition timing at which output torque becomes maximum)

The smaller the value of the knocking safety margin ignition timing, the easier abnormal combustion occurs. Depending on the speed of the internal combustion engine, the ease of occurrence of knocking differs. For this reason, the first combustion pressure control system changes the control pressure based on the speed of the internal combustion engine. In an internal combustion engine, overall, the higher the speed of the internal combustion engine, the shorter the combustion period, so the harder it is for abnormal combustion to occur.

FIG. 15 shows a graph of the control pressure versus the speed of the internal combustion engine in a first combustion pressure control system of the present embodiment. The higher the speed of the internal combustion engine, the higher the control pressure is set. Referring to FIG. 1, in the present embodiment, the value of the control pressure is stored in advance as a function of the speed of the internal combustion engine in the ROM 34 of the electronic control unit 31. The electronic control unit 31 uses the crank angle sensor 42 to detect the speed of the internal combustion engine and selects a control pressure in accordance with the speed. The electronic control unit 31 controls the gas feed device so that the gas pressure of the gas chamber 61 becomes the selected control pressure.

Further, the first combustion pressure control system in the present embodiment is provided with a fuel property detecting device which detects a property of the fuel. It uses the detected property of the fuel as the basis to change the control pressure. The fuel of an internal combustion engine sometimes contains alcohol. In the present embodiment, the explanation will be given with reference to an internal combustion engine which detects the concentration of alcohol as the property of the fuel. The properties of the internal combustion engine at the time of operation depend on the concentration of alcohol.

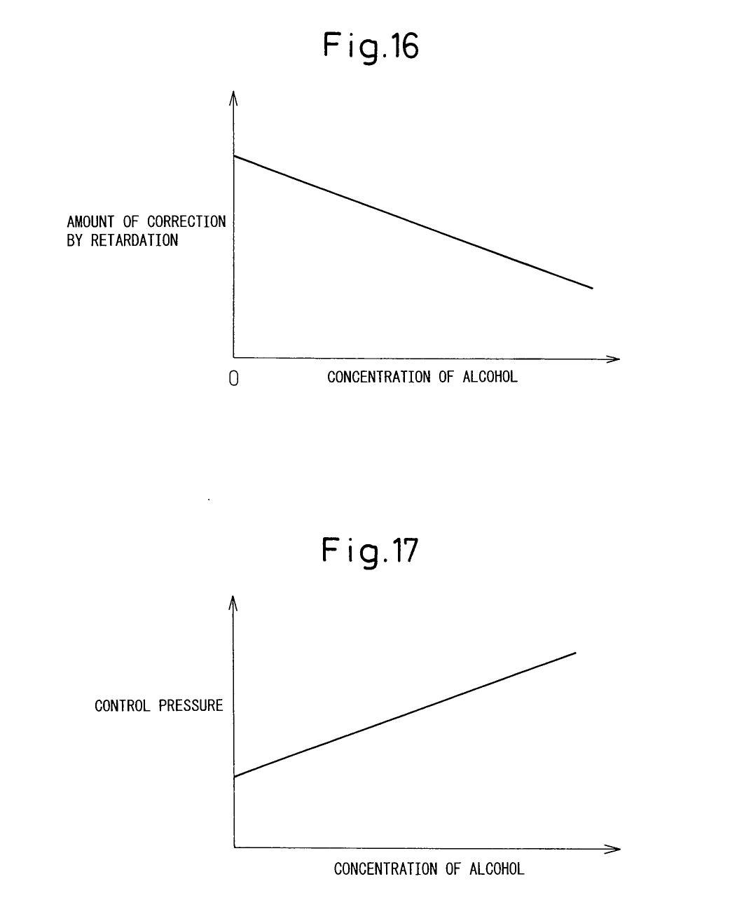

FIG. 16 shows a graph which explains the relationship between the concentration of alcohol which is contained in fuel and the amount of correction by retardation in an internal combustion engine of the comparative example. The internal combustion engine of the comparative example retards the ignition timing when abnormal combustion occurs. In FIG. 16, the abscissa indicates the concentration of alcohol which is contained in the fuel, while the ordinate indicates the amount of correction by retardation when retarding the ignition timing so that abnormal combustion does not occur. The higher the concentration of alcohol which is contained in the fuel, the smaller the amount of correction by retardation. In this way, in the internal combustion engine, the higher the alcohol concentration, the harder it is for abnormal combustion to occur. For this reason, the first combustion pressure control system uses the concentration of alcohol which is contained in the fuel as the basis to change the control pressure.

FIG. 17 shows a graph of the control pressure versus the concentration of alcohol in the first combustion pressure control system in the present embodiment. The higher the concentration of alcohol, the higher the control pressure is set. The fuel property detecting device in the present embodiment includes an alcohol concentration sensor which detects the concentration of alcohol which is contained in the fuel. Referring to FIG. 1, in the internal combustion engine in the present embodiment, the alcohol concentration sensor is arranged in the fuel feed flow path as the fuel property sensor 77. The value of the control pressure is stored as a function of the concentration of alcohol in advance in the ROM 34 of the electronic control unit 31. The electronic control unit 31 detects the concentration of alcohol which is contained in the fuel and selects the control pressure in accordance with the concentration of alcohol. The electronic control unit 31 controls the gas feed device so that the gas pressure of the gas chamber 61 becomes the selected control pressure.

In the internal combustion engine, the lower the temperature of the air-fuel mixture at the time of ignition, the harder it is for abnormal combustion to occur. As the operating state of the internal combustion engine, in addition to the speed of the internal combustion engine, the intake temperature, the cooling water temperature of the internal combustion engine, the temperature of the combustion chamber immediately before ignition, etc. may be mentioned. The lower these temperatures, the higher the control pressure can be set. Furthermore, when the compression ratio of the internal combustion engine is variable, the lower the compression ratio, the lower the temperature at the time of ignition becomes. For this reason, the lower the compression ratio, the higher the control pressure can be made.

Further, in the internal combustion engine, the greater the newly sucked in air or recirculated gas or other operating gas with respect to the fuel, the harder it is for abnormal combustion to occur. For this reason, as the operating state of the internal combustion engine, the amount of intake air, the flow rate of recirculated gas, and the air-fuel ratio at the time of burning can be illustrated. The greater the amount of operating gas with respect to the fuel, the higher the control pressure can be made.

As the properties of the fuel, in addition to the concentration of alcohol, the octane value of gasoline or another parameter indicating the knocking resistance can be illustrated. For example, it is possible to detect the feed of a fuel with a high octane value or other fuel where abnormal combustion is hard to occur to a combustion chamber and raise the control pressure.

By changing the control pressure in accordance with the operating state of the internal combustion engine or the properties of the fuel in this way, it is possible to suppress the occurrence of abnormal combustion while increasing the maximum pressure of a combustion chamber. It is therefore possible to suppress the occurrence of abnormal combustion while increasing the output torque or suppress the amount of consumption of fuel in accordance with operating state or the properties of the fuel. Note that, the combustion pressure control system may also simultaneously detect the operating state and the properties of the fuel to set the control pressure.

The control pressure changing device is not limited to the above. It is possible to employ any device which can change the control pressure. For example, when the biasing device which imparts a reaction force to the sub chamber-use piston includes a coil spring, it may be formed so that, when the sub chamber-use piston is seated at the bottom, the coil spring is pushed in the axial direction to enable the length of the coil spring to be changed.

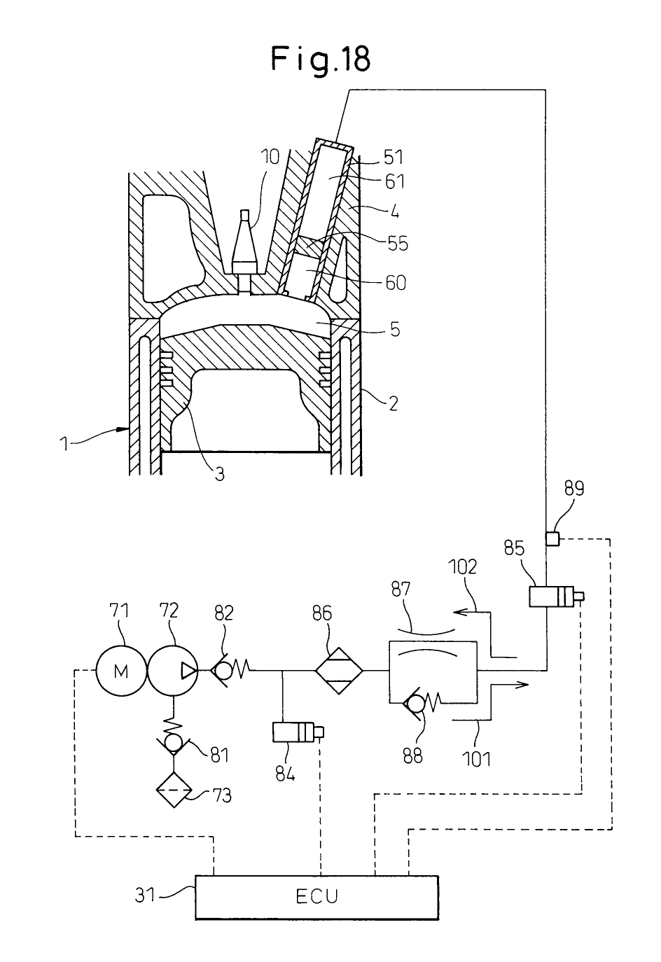

FIG. 18 is a schematic view of a second combustion pressure control system in the present embodiment. The second combustion pressure control system includes a gas feed device. The gas feed device of the second combustion pressure control system has the function of slowing the pressure reducing speed of the gas chamber 61. The gas feed device of the second combustion pressure control system has the function of temporarily lowering the speed of movement of the sub chamber-use piston when it is returning.

The gas feed device of the second combustion pressure control system in the present embodiment has, in addition to the configuration of the gas feed device of the first combustion pressure control system, a throttle valve comprised of an orifice 87. The orifice 87 is arranged in the flow path which connects the compressor 72 and the gas chamber 61. Furthermore, the check valve 88 is arranged in parallel with the orifice 87. The check valve 88 is arranged so that air flows from the compressor 72 toward the gas chamber 61. Further, in the middle of the flow path which connects the compressor 72 and the gas chamber 61, a dryer 86 for removing moisture is arranged.

The second combustion pressure control system drives the compressor 72 and opens the pressure regulator 86 in state when making the pressure of the gas chamber 61 rise. As shown by the arrow 101, air flows mainly through the check valve 88. At this time, air may also flow through the orifice 87. Further, when lowering the pressure of the gas chamber 61, the pressure regulator 85 and exhaust valve 84 are set open in state. Further, the compressor 72 may also be made to stop. At this time, air, as shown by the arrow 102, passes through the orifice 87 without passing through the check valve 88. The air which is exhausted passes through the orifice 87 whereby its flow rate is restricted. When reducing the pressure of the gas chamber 61, a large amount of air is exhausted in a short time and it is possible to keep the pressure of the gas chamber 61 from greatly falling. In this way, the second combustion pressure control system can slow the pressure reducing speed of the gas chamber 61.

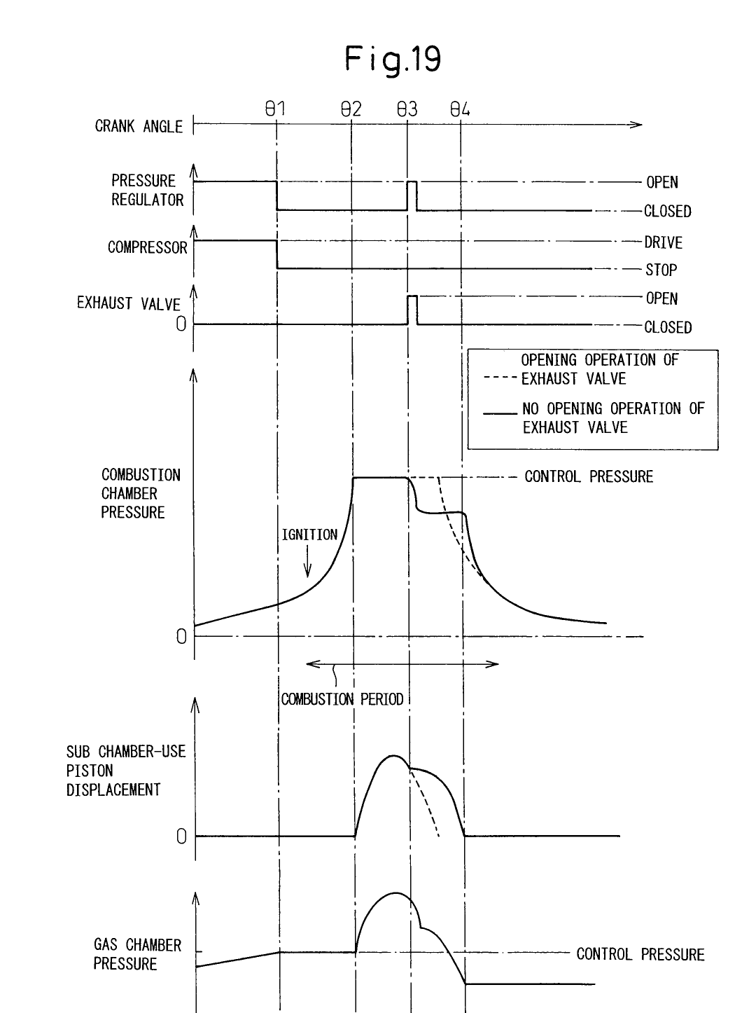

FIG. 19 is a time chart of an example of operation of the second combustion pressure control system in the present embodiment. FIG. 19 is a graph at the compression stroke and the expansion stroke. The abscissa indicates the crank angle. Referring to FIG. 18 and FIG. 19, in the period up to the crank angle θ1, the compressor 72 is in a driven state. Further, the pressure regulator 85 is open. The gas chamber 61 is filled with gas of the control pressure. At the crank angle θ1, the pressure of the gas chamber 61 reaches the control pressure. At the crank angle θ1, the pressure regulator 85 is closed and the compressor 72 is stopped. In the combustion chamber 5, the air-fuel mixture is ignited, whereby the pressure of the combustion chamber 5 rises.

At the crank angle θ2, the pressure of the combustion chamber 5 reaches the control pressure. At the crank angle θ2, the pressure of the combustion chamber 5 becomes substantially the same as the pressure of the gas chamber 61 and the sub chamber-use piston 55 starts to move. The pressure of the combustion chamber 5 is maintained substantially constant.

At the crank angle θ3, the pressure regulator 85 and the exhaust valve 84 are controlled to be temporarily opened in state. By opening the pressure regulator 85 and the exhaust valve 84, the pressure of the gas chamber 61 descends. At this time, air passes through the orifice 87, so it is possible to reduce the pressure of the gas chamber 61 down to a desired pressure. The displacement of the sub chamber-use piston 55 changes and the combustion chamber 5 is maintained at a pressure lower than the control pressure. At the crank angle θ4, the displacement of the sub chamber-use piston 55 becomes zero. At the crank angle θ4 on, the pressure of the combustion chamber 5 is reduced.

In the present embodiment, the timing for reducing the pressure of the inside of the gas chamber 61 is set to a timing in the latter half of the combustion period in which fuel is being burned. When dividing the combustion period into equal parts, the gas chamber 61 is reduced in pressure at a timing in the latter half (latter part). When the pressure of the combustion chamber 5 drops and the sub chamber-use piston 55 moves toward the combustion chamber 5, the speed of movement of the sub chamber-use piston 55 is made to temporarily fall. As a result, compared with the time when the sub chamber-use piston 55 moves toward the opposite side from the combustion chamber 5, the time when it moves toward the combustion chamber 5 becomes longer.

The second combustion pressure control system in the present embodiment can reduce the fluctuations in combustion in the latter part of the combustion period. In the latter part of the combustion period, the piston moves faster. Alternatively, amount of movement of the piston becomes larger. For this reason, if the pressure of a combustion chamber changes for every combustion cycle, the output torque of the internal combustion engine fluctuates.

The second combustion pressure control system can raise the pressure of a combustion chamber in the latter part of the combustion period and can improve the combustion properties in the latter part of the combustion period. For example, it is possible to raise the pressure of a combustion chamber at the crank angle θ4 higher than the case where there is no opening operation of the exhaust valve. For this reason, it is possible to reduce the fluctuation in the output torque which occurs for every combustion cycle. As a result, it is possible to reduce the fluctuations in the output torque which occur in the internal combustion engine. As the timing for reduction of the pressure of the gas chamber, a timing near the end of the combustion period may also be used.

The second combustion pressure control system can greatly retard the ignition timing so that the fluctuation of the output torque of the internal combustion engine becomes smaller. For example, referring to FIG. 1, in the internal combustion engine in the present embodiment, a three-way catalyst 20 is arranged in the engine exhaust passage. The three-way catalyst 20 has an activation temperature where the exhaust purification performance reaches a predetermined level. At the time of startup of the internal combustion engine etc., the three-way catalyst 20 is low in temperature and less than the activation temperature.

To make the three-way catalyst 20 the activation temperature or more, the temperature of the exhaust gas sometimes is raised. In a combustion chamber 5, it is possible to retard the ignition timing so as to make the temperature of the exhaust gas rise. However, if retarding the ignition timing, the fluctuation of the output torque becomes greater. In the internal combustion engine which is provided with the second combustion pressure control system, it is possible to reduce the fluctuation in the output torque, so it is possible to greatly retard the ignition timing. For this reason, it is possible to raise the temperature of the three-way catalyst or other exhaust purification device in a short time.

Further, since the fluctuation in the output torque of the internal combustion engine becomes smaller, it is possible to make the air-fuel ratio at the time of combustion larger. That is, it is possible to make the air-fuel ratio at the time of combustion leaner. By making the air-fuel ratio at the time of combustion larger, it is possible to improve the fuel consumption rate. However, by making the air-fuel ratio at the time of combustion leaner, fluctuation of the output torque occurs. In the internal combustion engine which is provided with the second combustion pressure control system, it is possible to suppress fluctuations in the output torque while increasing the air-fuel ratio at the time of combustion.

Further, when the internal combustion engine is provided with an exhaust gas recirculation (EGR) system, it is possible to raise the recirculation rate so as to reduce the pumping loss. However, by raising the recirculation rate of the exhaust gas, the combustion period becomes longer and the fluctuation in the output torque becomes larger. In the internal combustion engine which is provided with the second combustion pressure control system, it is possible to suppress fluctuation of the output torque while raising the recirculation rate of the exhaust gas.

In this way, in the internal combustion engine which is provided with the second combustion pressure control system, by suppressing fluctuations of the output torque, it is possible to greatly retard the ignition timing, increase the air-fuel ratio at the time of combustion, and raise the recirculation rate of the exhaust gas.

In the second combustion pressure control system in the present embodiment, the check valve and orifice are used to drain a predetermined amount of gas from the gas chamber during the combustion period, but the invention is not limited to this. It is possible to employ any device which can exhaust the desired amount of air from the gas chamber in the combustion period. Alternatively, it is possible to employ any device which lowers the speed of movement of the sub chamber-use piston.

The rest of the configuration, action, and effects are similar to those of any of the Embodiment 1, so the explanations will not be repeated here.

### Embodiment 3

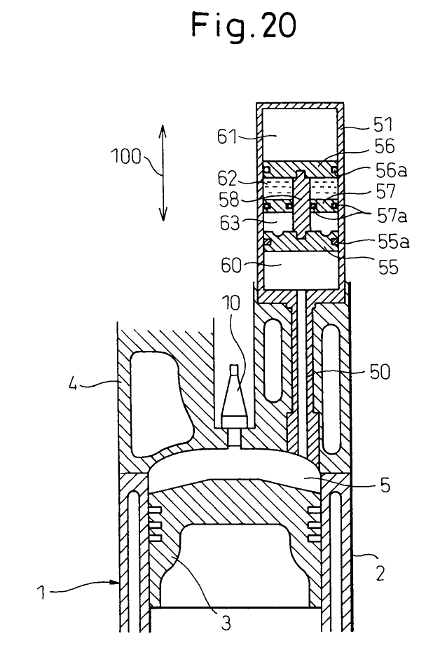

Referring to FIG. 20 to FIG. 28, the combustion pressure control system of the internal combustion engine in the Embodiment 3 will be explained. The combustion pressure control system in the present embodiment is provided with a sub chamber-use piston and gas chamber-use piston as the moving member of the volume changing device. In the present embodiment, the explanation will be given with reference to the example of a volume changing device with a sealed gas chamber, but it is also possible that a gas feed device which feeds gas to the gas chamber be connected.

FIG. 20 is a schematic cross-sectional view of a first combustion pressure control system in the present embodiment. The moving member of the volume changing device in the present embodiment includes the sub chamber-use piston 55 and the gas chamber-use piston 56. The gas chamber-use piston 56 is fastened to the sub chamber-use piston 55 via a connecting rod 58. The moving member in the present embodiment also includes the intermediate piston 57 which is arranged between the sub chamber-use piston 55 and the gas chamber-use piston 56. These plurality of pistons are arranged at the inside of the tubular member 51.

At the outer circumferential surface of the gas chamber-use piston 56, an O-ring 56a is arranged. The seal between the gas chamber-use piston 56 and the tubular member 51 is maintained by this. The intermediate piston 57 in the present embodiment is arranged so as to be able to freely move along the axial direction of the connecting rod 58. O-rings 57a are arranged at the inner circumferential surface and outer circumferential surface of the intermediate piston 57. The seals between the intermediate piston 57 and the connecting rod 58 and between the intermediate piston 57 and the tubular member 51 are maintained by these.

In the present embodiment, an air chamber 63 is formed between the intermediate piston 57 and the sub chamber-use piston 55. The air chamber 63 is filled with air. Further, an oil chamber 62 is formed between the intermediate piston 57 and the gas chamber-use piston 56. The oil chamber 62 is filled with oil.

The biasing device of the combustion pressure control system in the present embodiment includes a gas chamber 61 and uses the gas pressure of the gas chamber 61 to bias the moving member toward the combustion chamber 5 side. In the present embodiment, the sub chamber-use piston 55, gas chamber-use piston 56, and intermediate piston 57, as shown by the arrow 100, move integrally in the axial direction of the tubular member 51. Further, the intermediate piston 57 moves following the gas chamber-use piston 56. In this way, the oil chamber 62 and air chamber 63 move simultaneously with the plurality of pistons.

In the volume changing device in the present embodiment, the sub chamber-use piston 55 and the gas chamber-use piston 56 move integrally, whereby the oil of the oil chamber 62 is coated on the inner surface of the tubular member 51. For this reason, it is possible to improve the seal of the piston ring 55a which is arranged at the outer circumferential surface of the sub chamber-use piston 55 and the O-ring 56a which is arranged at the outer circumferential surface of the gas chamber-use piston 56. It is therefore possible to keep gas from leaking from the gas chamber 61 or gas from leaking from the sub chamber 60. Further, by the oil being coated on the inner surface of the tubular member 51, the movement of the moving member becomes smoother. For this reason, it is possible to suppress pulsation of the pressure of the combustion chamber 5 (see FIG. 7) which occurs when the moving member moves.

Further, the intermediate piston 57 of the moving member in the present embodiment is arranged to be able to freely move in the axial direction of the tubular member 51. The intermediate piston 57 can be fastened to the connecting rod 58. However, the temperature of the outside air and the high temperature gas from a combustion chamber 5 which flows into the sub chamber 60 sometime cause changes in the temperature of the oil which is filled in the oil chamber 62 resulting in expansion or shrinkage of the oil. By arranging the intermediate piston 57 to be movable without fastening it to the connecting rod 58, it is possible for the oil chamber 62 to change in volume and match with the expansion or shrinkage of the oil.

In the volume changing device in the present embodiment, the tubular part comprised of the tubular member 51 is connected through the connecting pipe 50 to a combustion chamber 5. The connecting pipe 50 has a diameter which is smaller than the diameter of the sub chamber 60. The tubular member 51 is connected through the connecting pipe 50 to the combustion chamber 5, whereby a distance can be provided between the sub chamber 60 and the combustion chamber 5 and the heat of the combustion chamber 5 can be kept from being conducted to sub chamber 60. For example, it is possible to keep the heat of the combustion chamber 5 from being conducted through the inside of the cylinder head 4 and reaching the sub chamber 60. Alternatively, it is possible to cool the combustion gas when high temperature combustion gas passes through the connecting pipe 50.

Further, in the present embodiment, an air chamber 63 is interposed between the gas chamber 61 and the sub chamber 60. That is, a space of a gas is arranged between the gas chamber 61 and the sub chamber 60. Due to this configuration, it is possible to keep the heat of the combustion gas which flows into the sub chamber 60 from being conducted to the gas chamber 61. It is therefore possible to keep the temperature of the gas of the gas chamber 61 from changing and the pressure of the gas chamber 61, that is, the control pressure, from changing.

In the present embodiment, an air chamber is interposed between the gas chamber and the sub chamber, but the invention is not limited to this. It is possible to interpose a chamber in which any gas is sealed. As the gas which is sealed, a gas with a small heat conduction rate is preferably used. Alternatively, the air chamber is reduced in pressure to lower the heat conduction. Furthermore, instead of the air chamber, it is also possible to arrange a chamber containing a substance with a heat insulating property.

The first combustion pressure control system in the present embodiment has substantially the same diameter of the sub chamber 60 and diameter of the gas chamber 61, but the invention is not limited to this. The diameter of the sub chamber 60 and the diameter of the gas chamber 61 may also be different.

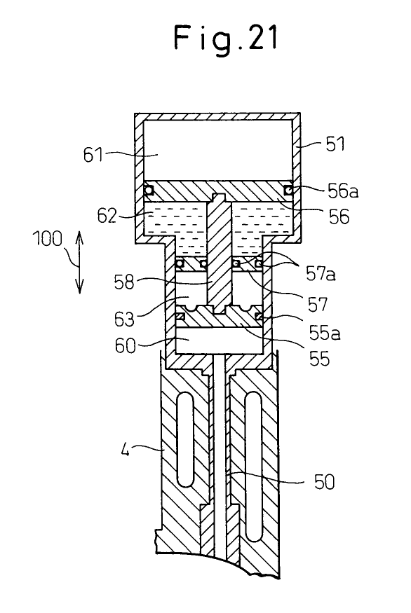

FIG. 21 is a schematic cross-sectional view of a second combustion pressure control system in the present embodiment. The second combustion pressure control system is formed so that the diameter of the sub chamber 60 and the diameter of the gas chamber 61 are different from each other. When cutting the tubular member 51 in the direction vertical to the axial direction, compared with the cross-sectional area of the sub chamber-use piston 55, the cross-sectional area of the gas chamber-use piston 56 becomes larger. By employing this configuration, it is possible to reduce the pressure of the gas which is filled in the gas chamber 61. Further, when the combustion pressure control system is provided with a gas feed device which feeds gas to the gas chamber 61, it is possible to lower the pressure of the fed gas, so it is possible to simplify the configuration of the gas feed device.

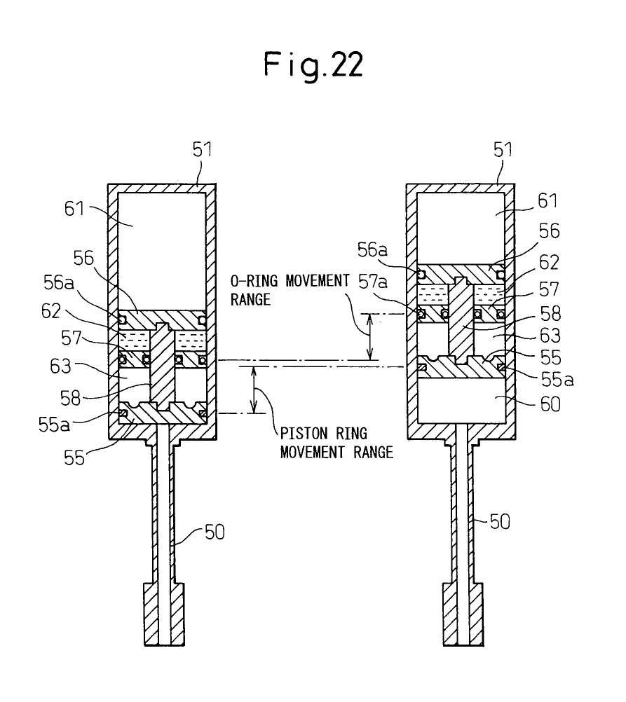

FIG. 22 is a schematic cross-sectional view of a third combustion pressure control system in the present embodiment. FIG. 22 shows a schematic cross-sectional view in the case where the displacement of the sub chamber-use piston is zero and the case where the displacement of the sub chamber-use piston is maximum. The piston ring 55a which is arranged at the outer circumferential surface of the sub chamber-use piston 55 functions as the first sealing member. The O-rings 57a which are arranged at the inner circumferential surface and the outer circumferential surface of the intermediate piston 57 function as the second sealing member. The O-ring 56a which is arranged at the outer circumferential surface of the gas chamber-use piston 56 functions as the third sealing member. The O-rings 56a and 57a are, for example, formed from rubber.

The volume changing device of the third combustion pressure control system in the present embodiment is formed so that the range of movement of the piston ring 55a and the range of movement of the O-rings 57a do not overlap. That is, the range of movement of the O-rings 57a which are arranged at the intermediate piston 57 is formed to become outside of the range of movement of the piston ring 55a. For example, the connecting rod 58 is formed sufficiently long and is formed so that the distance between the intermediate piston 57 and the sub chamber-use piston 55 becomes large.

The region at the inner surface of the tubular member 51 where the piston ring 55a moves is preferably formed with grooves for storing lubricating oil. As opposed to this, the region at the inner surface of the tubular member 51 where the O-ring 57a moves is preferably smooth so as to secure a seal. By separating the region where the piston ring 55a moves and the region where the O-rings 57a move like in the present embodiment, it is possible to form the inner surface of the tubular member 51 so that the seal with respect to these sealing members is improved.

In the present embodiment, the region in which the piston ring 55a moves is formed with fine grooves called “cross hatching” for storing lubricating oil. Further, the region in which the O-rings 57a move and the region in which the O-ring 56a moves are not formed with grooves etc., but are formed smooth. That is, the tubular member 51 is formed so that the surface roughness of its inner surface becomes small. Due to this configuration, it is possible to keep oil from leaking from the oil chamber 62 or gas from leaking from the gas chamber 61. Further, by forming cross hatching, it is possible to improve the lubricating ability of the piston ring 55a.

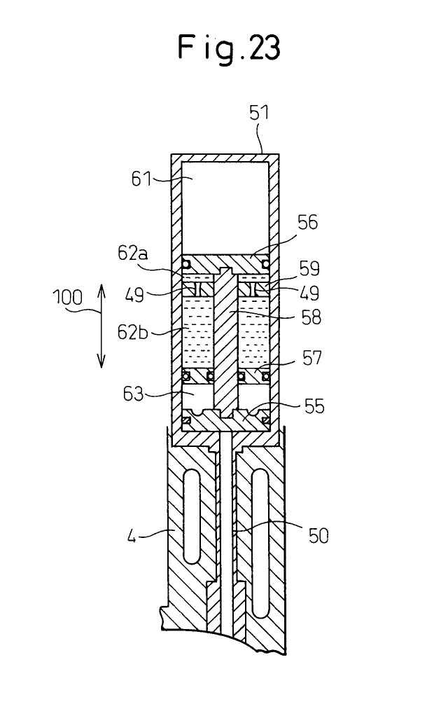

FIG. 23 is a schematic cross-sectional view of a fourth combustion pressure control system in the present embodiment. FIG. 23 is a schematic cross-sectional view of when the displacement of the sub chamber-use piston 55 is zero. The fourth combustion pressure control system in the present embodiment includes a partition part 59 which is arranged between the intermediate piston 57 and gas chamber-use piston 56. The partition part 59 is arranged so as to divide a single oil chamber. An oil chamber 62a and oil chamber 62b are therefore formed. The partition part 59 is fastened to the tubular member 51.

The partition part 59 is formed with orifices 49 so that the two oil chambers 62a and 62b are communicated with each other. The orifices 49 pass through the partition part 59. The orifices 49 are formed so as to restrict the flow rate of oil which flows between the oil chamber 62a and the oil chamber 62b.

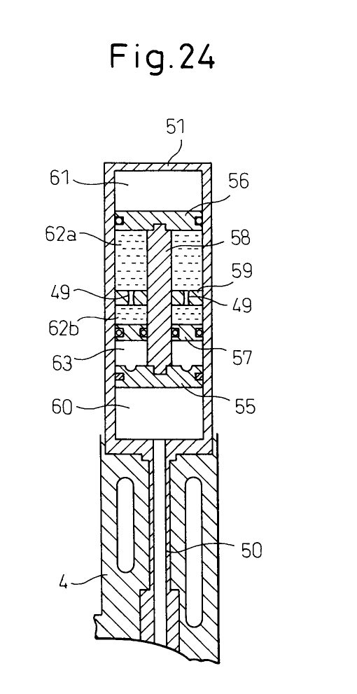

FIG. 24 is another schematic cross-sectional view of a fourth combustion pressure control system in the present embodiment. FIG. 24 is a schematic cross-sectional view of when the displacement of the sub chamber-use piston 55 becomes maximum. When the displacement of the sub chamber-use piston 55 becomes large, oil flows from the oil chamber 62b to the oil chamber 62a. Further, when the displacement of the sub chamber-use piston 55 becomes small, the oil flows from the oil chamber 62a to the oil chamber 62b.

When the oil flows between the oil chamber 62a and the oil chamber 62b, it passes through the orifices 49, so it is possible to make the movement of the sub chamber-use piston 55 low in speed. For this reason, it is possible to suppress noise and vibration when the sub chamber-use piston 55 moves. Further, sometimes the sub chamber-use piston 55 bounces back when being seated at the bottom of the tubular member 51. By the sub chamber-use piston 55 bouncing back, the volume of the sub chamber 60 changes for an instant and a detrimental effect is given to the pressure of the combustion chamber 5 in some cases. By arranging the partition part 59 having the orifices 49 at the oil chamber, it is possible to keep the sub chamber-use piston 55 from bouncing back in this way. It is therefore possible to reduce noise and vibration occurring when the sub chamber-use piston 55 bounces back. It is therefore possible to suppress any detrimental effect on the pressure of a combustion chamber 5.

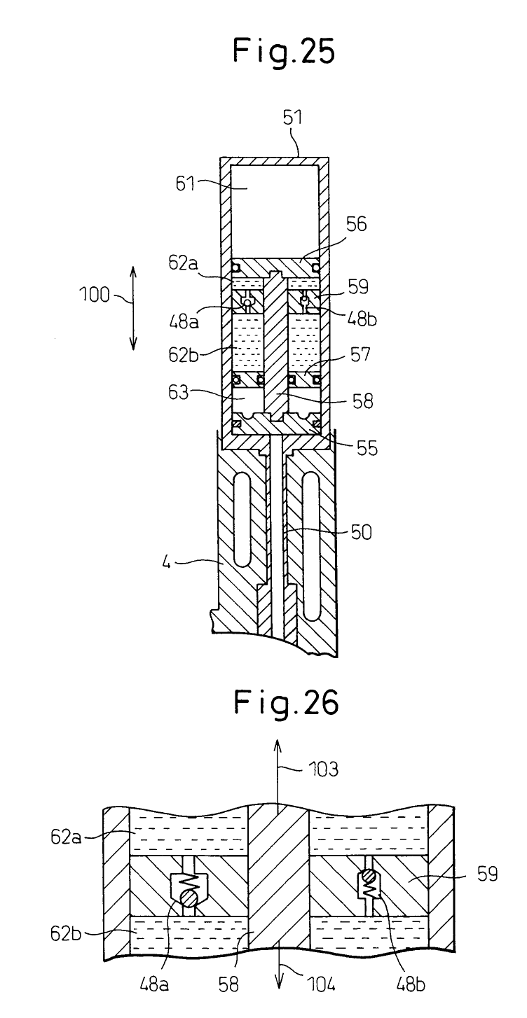

FIG. 25 is a schematic cross-sectional view of a fifth combustion pressure control system in the present embodiment. The fifth combustion pressure control system includes a partition part 59 which is fastened to the tubular member 51. The partition part 59 is arranged inside of the oil chamber. In the partition part 59, a first check valve constituted by the check valve 48a and a second check valve constituted by the check valve 48b are arranged.

FIG. 26 is an enlarged schematic cross-sectional view of part of the partition part of the fifth combustion pressure control system. The check valve 48a is formed so that oil flows when the pressure of the oil chamber 62b becomes higher than the pressure of the oil chamber 62a. The check valve 48b is formed so that oil flows when the pressure of the oil chamber 62a becomes higher than the pressure of the oil chamber 62b.

The present embodiment is formed so that when the absolute values of the pressure differences become equal between the oil chamber 62a and oil chamber 62b, the flow rate through the check valve 48b becomes smaller than the flow rate through the check valve 48a. The check valves 48a and 48b are formed so that the maximum flow rate of the check valve 48b becomes smaller than the maximum flow rate of the check valve 48a.

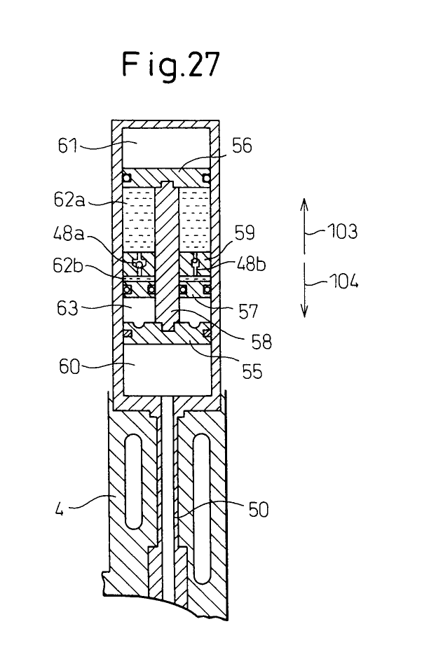

FIG. 27 is another schematic cross-sectional view of a fifth combustion pressure control system in the present embodiment. FIG. 27 is a schematic cross-sectional view of when the displacement of the sub chamber-use piston 55 becomes maximum. When the displacement of the sub chamber-use piston 55 becomes large, that is, when the volume of the sub chamber becomes large, the oil of the oil chamber 62b passes through the check valve 48a and flows into the oil chamber 62a. On the other hand, when the displacement of the sub chamber-use piston 55 becomes small, that is, when the volume of the sub chamber becomes small, the oil of the oil chamber 62a passes through the check valve 48b and flows into the oil chamber 62b. Referring to FIG. 26 and FIG. 27, when the sub chamber-use piston 55 moves in the direction shown by the arrow 103, it moves by a large speed of movement. When the sub chamber-use piston 55 moves in the direction shown by the arrow 104, it moves by a small speed of movement.

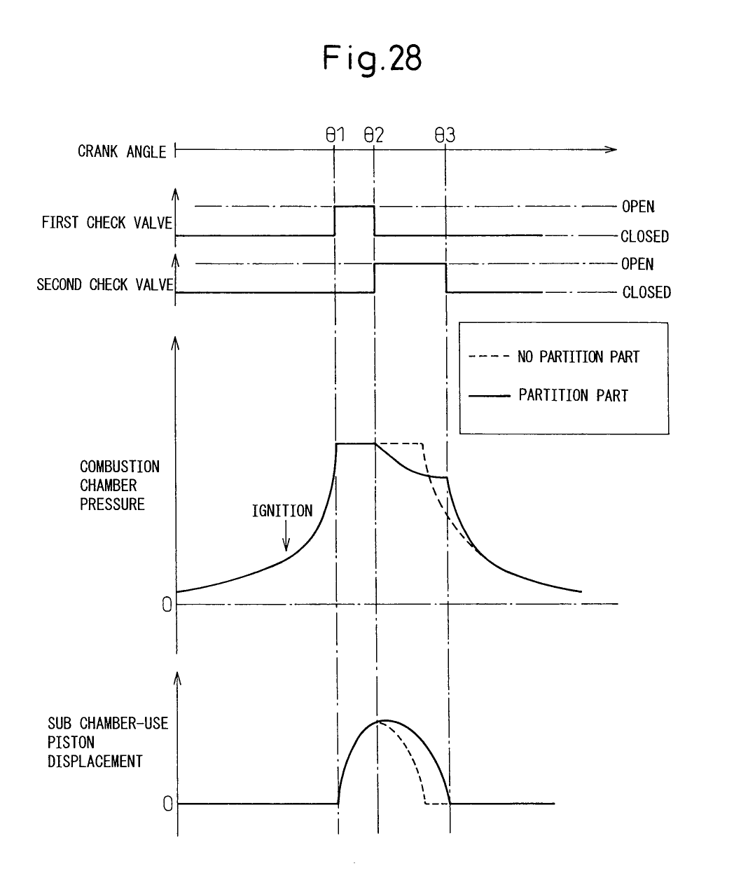

FIG. 28 is a time chart of the compression stroke and the expansion stroke in the fifth combustion pressure control system of the present embodiment. The abscissa indicates the crank angle. The solid lines show the fifth combustion pressure control system, while the broken lines show a combustion pressure control system which does not have a partition part.

In a combustion chamber, combustion starts whereupon the pressure of the combustion chamber rapidly rises. At the crank angle θ1, the pressure of the combustion chamber reaches the control pressure. The sub chamber-use piston 55 then starts to move. Up to the crank angle θ2, the check valve 48a opens and oil flows from the oil chamber 62b to the oil chamber 62a. From the crank angle θ1 to the crank angle θ2, the sub chamber-use piston rises by a large speed in the direction shown by the arrow 103.

When the displacement of the sub chamber-use piston 55 becomes small, the oil which is stored in the oil chamber 62a passes through the check valve 48b and flows into the oil chamber 62b. From the crank angle θ2 to the crank angle θ3, oil flows by opening the check valve 48b. At this time, the flow rate of the oil is restricted at the check valve 48b. The speed by which the displacement of the sub chamber-use piston 55 returns to zero becomes slower. At the crank angle θ3, the displacement of the sub chamber-use piston 55 returns to zero.

The sub chamber-use piston 55 is reduced in displacement by a slow speed toward zero, so the pressure of the combustion chamber 5 right after the crank angle θ2 becomes lower than the case not having a partition part. However, at the latter part of the combustion period, the pressure of the combustion chamber rises. For example, near the crank angle θ3, the pressure of the combustion chamber becomes higher than the case not having a partition part. The combustion properties in the latter part of the combustion period are improved and fluctuations in the output torque of the internal combustion engine can be reduced. For this reason, in the same way as the second combustion pressure control system of the Embodiment 2 (see FIG. 18 and FIG. 19), it is possible to suppress fluctuations in the output torque while greatly retarding the ignition timing, to greatly increase the air-fuel ratio of the exhaust gas, or to raise the recirculation rate of the exhaust gas.

By making the speed by which the volume of the sub chamber becomes smaller slower than the speed by which the volume of the sub chamber becomes larger in this way, it is possible to improve the combustion properties in the latter part of the combustion period. Furthermore, it is possible to slow the speed when the displacement of the sub chamber-use piston returns to zero, so it is possible to reduce vibration or noise of the moving member. For example, it is possible to reduce the vibration or noise when the sub chamber-use piston is seated at the bottom of the tubular member.

The rest of the configuration, action, and effects are similar to those of any of Embodiment 1 or 2, so the explanations will not be repeated here.

### Embodiment 4

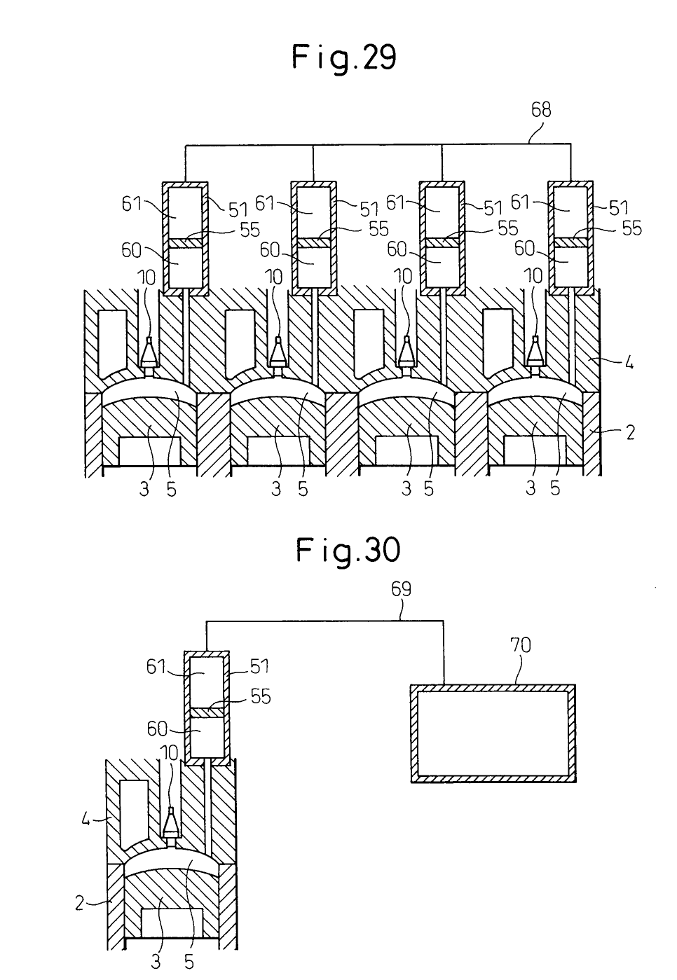

Referring to FIG. 29 to FIG. 31, the combustion pressure control system in the Embodiment 4 will be explained. In the present embodiment, the explanation will be given with reference to the example of a volume changing device with a sealed gas chamber, but it is also possible that a gas feed device which feeds gas to the gas chamber be connected.

FIG. 29 is a schematic view of a first combustion pressure control system in the present embodiment. The internal combustion engine provided with the first combustion pressure control system has a plurality of combustion chambers. In the example shown in FIG. 29, a four-cylinder internal combustion engine is shown. This internal combustion engine is provided with a first cylinder, a second cylinder, a third cylinder, and a fourth cylinder. Further, in the present embodiment, the first cylinder, the third cylinder, the fourth cylinder and the second cylinder are ignited in that order. That is, the ignition timing differs for each cylinder.

In the first combustion pressure control system, a volume changing device is arranged for each combustion chamber 5. At each volume changing device, a sub chamber-use piston 55 is arranged at the inside of a tubular member 51. At the inside of the tubular member 51, a sub chamber 60 and a gas chamber 61 are formed. The plurality of gas chambers 61 are connected with each other by a connecting pipe 68.

Sometimes the heat of the combustion gas which flows into the sub chamber 60 causes the temperature of the gas chamber 61 to rise. By connecting the plurality of gas chambers 61 with each other, it is possible to suppress the change in pressure accompanying a change in temperature of a gas chamber 61. Further, in the internal combustion engine in the present embodiment, the ignition timings of the cylinders differ from each other. Furthermore, the plurality of gas chambers 61 are connected with each other by the connecting pipe 68. For this reason, in the same way as the case of provision of the later explained auxiliary tank, when the sub chamber-use piston 55 moves, the volume of the gas chamber 61 substantially becomes larger. For this reason, it is possible to suppress a rise in pressure of the gas chamber 61 accompanying movement of the sub chamber-use piston 55.

FIG. 30 is a schematic view of the second combustion pressure control system in the present embodiment. The second combustion pressure control system includes an auxiliary tank 70. The auxiliary tank 70 is connected through a connecting pipe 69 to the gas chamber 61. Connecting the auxiliary tank 70 to the gas chamber 61 is substantially equivalent to the volume of the gas chamber 61 becoming larger.

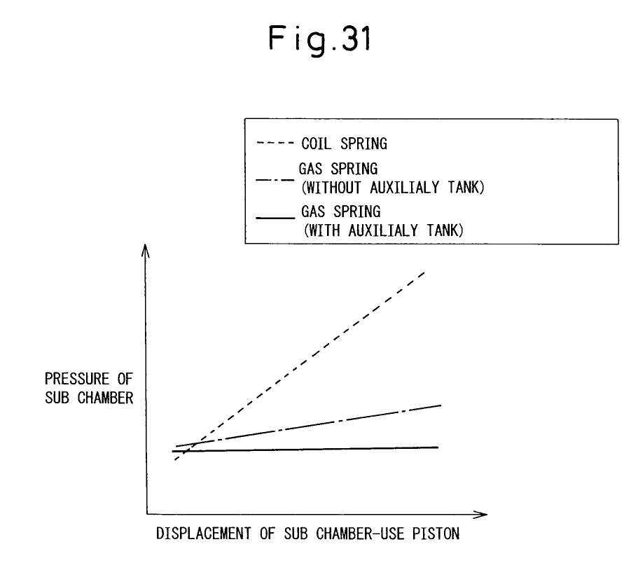

FIG. 31 shows a graph for explaining the relationship between the displacement of the sub chamber-use piston and the pressure of the sub chamber. FIG. 31 shows the case where the biasing device which biases the sub chamber-use piston includes a coil spring and the case where it includes a gas chamber (case of gas spring). When the biasing device includes a coil spring, the larger the displacement of the sub chamber-use piston becomes, the larger the pressure of the sub chamber becomes.

In a gas biasing device including a gas chamber, the larger the volume of the gas chamber, the smaller the rise in pressure of the gas chamber can be made. For this reason, even if the displacement of the sub chamber-use piston becomes large, the rise of the pressure of the sub chamber can be reduced. By connecting an auxiliary tank to the gas chamber, a rise of the pressure of the sub chamber can be suppressed.

In particular, even when the displacement of the sub chamber-use piston becomes large, the pressure of the sub chamber can be maintained substantially constant. As a result, as shown in FIG. 7, when the sub chamber-use piston moves, the pressure of the combustion chamber can be kept from rising (the graph of the pressure of the combustion chamber becomes one projecting upward). The rise of the pressure of the combustion chamber can be reduced and, during the period of movement of the sub chamber-use piston, the pressure of the combustion chamber can be maintained substantially constant.

The rest of the configuration, action, and effects are similar to those of any of Embodiments 1 to 3, so the explanations will not be repeated here.

### Embodiment 5

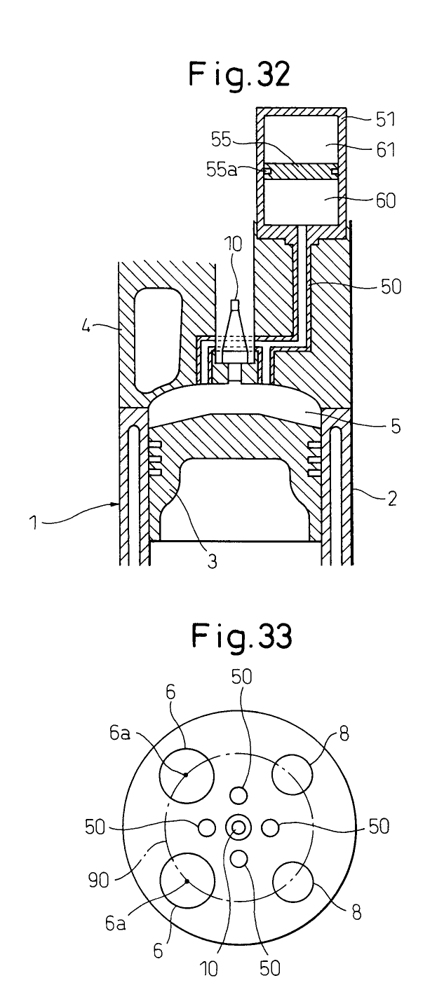

Referring to FIG. 32 to FIG. 38, the combustion pressure control system of the internal combustion engine in the Embodiment 5 will be explained. In the present embodiment, the explanation will be given with reference to the example of a volume changing device with a sealed gas chamber, but it is also possible that a gas feed device which feeds gas to the gas chamber be connected.

FIG. 32 is a schematic cross-sectional view of a first combustion pressure control system in the present embodiment. In the first combustion pressure control system in the present embodiment, the sub chamber 60 is arranged separated from the combustion chamber 5. The first combustion pressure control system is provided with a connecting pipe 50 which connects the combustion chamber 5 and the sub chamber 60.

FIG. 33 is a schematic plan view which explains the arrangement of the first combustion pressure control system in the combustion chamber. The internal combustion engine in the present embodiment is provided with two intake valves 6 and two exhaust valves 8. Referring to FIG. 32 and FIG. 33, the connecting pipe 50 is branched in the middle and is connected to the combustion chamber 5 at a plurality of locations. The branched connecting pipe 50 is connected to the combustion chamber 5 near the spark plug 10. The connecting pipe 50 is arranged to surround the spark plug 10. The connecting pipe 50 in the present embodiment is connected to the combustion chamber at the inside of a circle 90 when defining a circle 90 along the outer shape of the combustion chamber 5 so as to pass through the centers 6a of the plane view shaped circles of the intake valves 6. Furthermore, it is preferably connected to the combustion chamber 5 at the inside of another circle when defining another circle along the outer shape of the combustion chamber 5 so as to pass through the centers of the plane view shaped circles of the exhaust valves 8.

Near the spark plug 10, fuel burns right after ignition. Near the spark plug 10, the fuel burns before the pressure of the combustion chamber 5 reaches the control pressure. That is, the fuel burns before the gas flows to the connecting pipe 50. By having the connecting pipe 50 connected near the spark plug 10, it is possible to keep unburned fuel from entering the connecting pipe 50 and sub chamber 60.

If unburned fuel enters the connecting pipe 50 and sub chamber 60, when the gas of the sub chamber 60 returns to the combustion chamber 5, the unburned fuel flows to the combustion chamber 5. For this reason, sometimes the combustion characteristics in the combustion chamber 5 change. By connecting the connecting pipe 50 near the spark plug 10, it is possible to avoid such changes in the combustion characteristics.

Further, by keeping the unburned fuel from entering the connecting pipe 50 and sub chamber 60, it is possible keep part of the fuel from being exhausted to the engine exhaust passage without being burned. For this reason, it is possible to keep the amount of fuel consumption from increasing. Alternatively, it is possible to keep the amount of unburned fuel which is discharged into the atmosphere from increasing. Alternatively, it is possible to keep unburned fuel from flowing into the exhaust purification device and the temperature of the exhaust purification device from becoming excessively hot.

The connecting pipe 50 is preferably formed with a small inside diameter so that flame will not enter and pass to the sub chamber 60. For example, the connecting pipe 50 preferably has a diameter smaller than the diameter of the sub chamber 60. Alternatively, the connecting pipe 50 is preferably formed long so that flame does not enter the sub chamber 60. Further, by connecting the connecting pipe 50 to the combustion chamber 5 at a plurality of locations, it is possible to reduce the pressure loss of the connecting pipe 50. In particular, it is possible to reduce the pressure loss of the connecting pipe when making the diameter of the part which is connected to the combustion chamber 5 smaller.

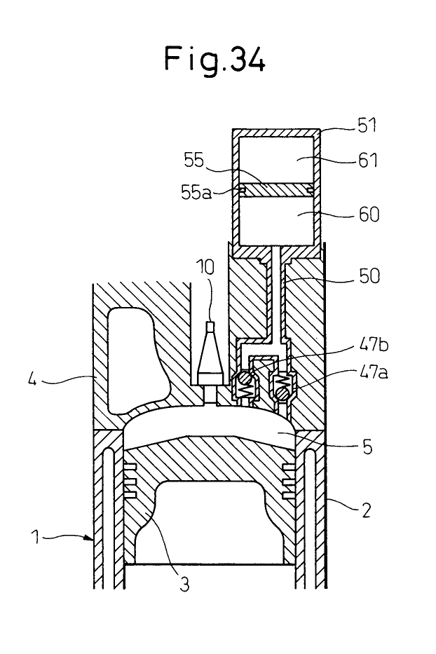

FIG. 34 is a schematic cross-sectional view of a second combustion pressure control system in the present embodiment. The second combustion pressure control system in the present embodiment has the connecting pipe 50 branched in the middle whereby a plurality of flow paths are formed. Each of the plurality of flow paths has a first check valve comprised of a check valve 47a and a second check valve comprised of a check valve 47b arranged in it.

The check valve 47a is arranged in the direction of flow of gas when the pressure of the combustion chamber 5 is larger than the pressure of the sub chamber 60. The pressure at which the check valve 47a opens (cranking pressure) is set to the pressure at which the sub chamber-use piston 55 starts to move, that is, the control pressure. The check valve 47a is formed so that gas flows when the pressure of the combustion chamber 5 becomes the control pressure or more. The check valve 47b is arranged in the direction of flow of gas when the pressure of the sub chamber 60 is larger than the pressure of the combustion chamber 5. The check valve 47b is formed so that gas flows by a slight pressure difference.

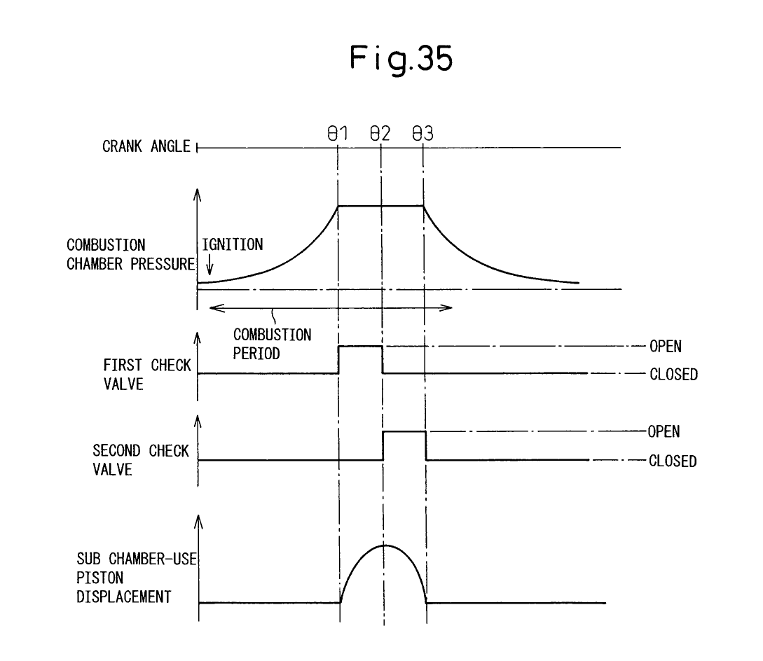

FIG. 35 is a time chart for explaining the operation of the second combustion pressure control system in the present embodiment. FIG. 35 is a time chart at the compression stroke and the expansion stroke. By ignition in the combustion chamber 5, the pressure of the combustion chamber 5 rapidly rises. At the crank angle θ1, the pressure of the combustion chamber 5 reaches the control pressure. When the pressure of the combustion chamber 5 reaches the control pressure, the check valve 47a opens and the gas flows into the sub chamber 60.

From the crank angle θ1 to the crank angle θ2, gas flows through the check valve 47a from the combustion chamber 5 to the sub chamber 60. At the crank angle θ2, the displacement of the sub chamber-use piston 55 becomes maximum. From the crank angle θ2 to the crank angle θ3, gas flows through the check valve 47b from the sub chamber 60 to the combustion chamber 5. At the crank angle θ3, the displacement of the sub chamber-use piston 55 returns to zero.

In the second combustion pressure control system, when the pressure of the combustion chamber 5 is less than the control pressure, the sub chamber 60 is cut off from the combustion chamber 5. For this reason, it is possible to suppress the inflow of unburned fuel to the connecting pipe 50. Further, when the pressure of the combustion chamber 5 reaches the control pressure, the fuel starts to burn. At the crank angle θ1, the burning of the fuel progresses, so the unburned fuel which remains in the combustion chamber becomes smaller than the unburned fuel at the ignition timing. For this reason, it is possible to keep the unburned fuel entering the connecting pipe 50 and sub chamber 60.

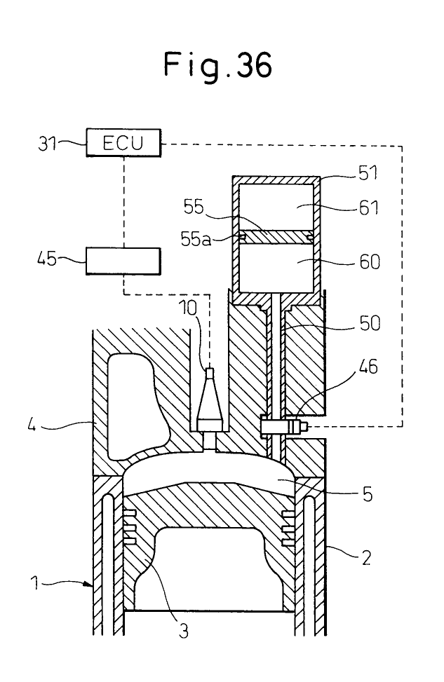

FIG. 36 is a schematic view of a third combustion pressure control system in the present embodiment. The third combustion pressure control system includes a shut-off valve 46 which is arranged in the connecting pipe 50. The shut-off valve 46 in the present embodiment is a solenoid valve. The shut-off valve 46 is controlled by the electronic control unit 31.

The third combustion pressure control system is provided with a combustion period detecting device for detecting a combustion period in the combustion chamber 5. The combustion period detecting device in the present embodiment includes an ion current detecting device 45. When the fuel burns in combustion chamber 5, ions are generated. The ion current detecting device applies a voltage across the electrodes and detects the flowing ion current so as to detect the burning state of the fuel.

The ion current detecting device in the present embodiment is connected to a spark plug 10. After the spark plug 10 is used to ignite the air-fuel mixture, the ion current detecting device 45 applies voltage across the electrodes of the spark plug. The ion current detecting device 45 detects the ion current so as to judge if fuel is being burned in the combustion chamber 5. For example, it can be judged that fuel is being burned when the detected ion current is larger than a predetermined judgment value.

The combustion period detecting device is not limited to an ion current detecting device. Any device which can detect the combustion period may be employed. For example, as the combustion period detecting device, a temperature sensor which detects the temperature inside of the combustion chamber or a pressure sensor which detects the pressure inside of the combustion chamber may also be arranged.

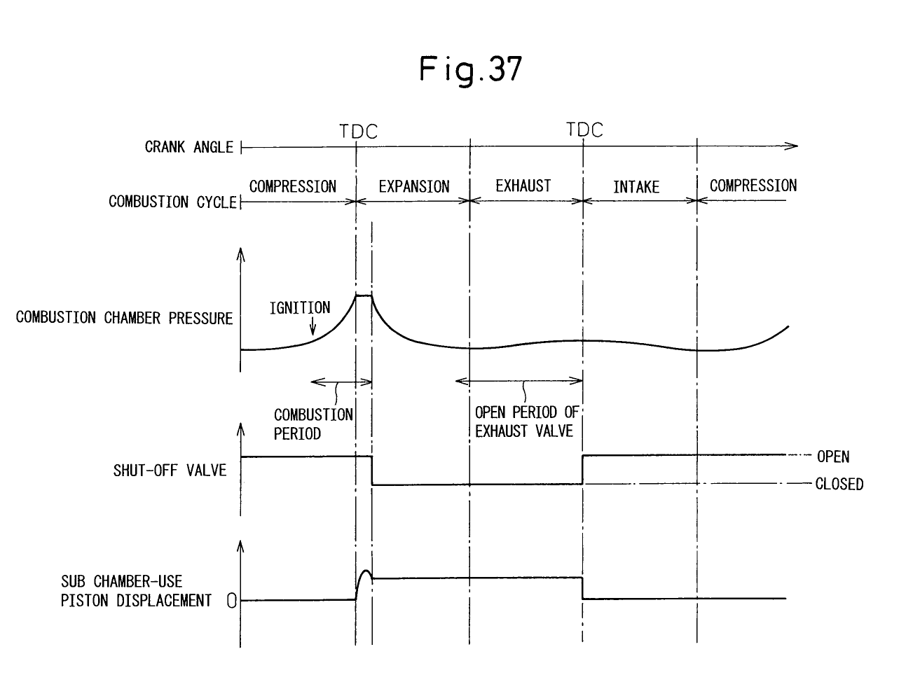

FIG. 37 shows a time chart for explaining an example of operation of the third combustion pressure control system in the present embodiment. FIG. 37 shows the case where fuel combustion is ended during the period when the pressure of the combustion chamber has reached the control pressure.

Referring to FIG. 36 and FIG. 37, the combustion cycle has an compression stroke, an expansion stroke, an exhaust stroke, and an intake stroke. The fuel starts to be burned by ignition of the air-fuel mixture. The shut-off valve 46 is maintained in the open state during the combustion period. The ion current detecting device 45, for example, detects when the ion current becomes smaller than a judgment value and thereby judges that the combustion period has ended. The electronic control unit 31 detects that the combustion period has ended and closes the shut-off valve 46. The sub chamber-use piston 55 stops in the middle without returning to zero displacement.

The shut-off valve 46 is maintained in the closed state in the expansion stroke and the exhaust stroke after being closed. The shut-off valve 46 is controlled to open after the end of the period in which the exhaust valve 8 is open. Alternatively, the shut-off valve 46 is controlled to open during the period of the intake stroke. By the shut-off valve 46 opening, the displacement of the sub chamber-use piston 55 returns to zero

By the fuel burning, the sub chamber-use piston 55 moving, and the sub chamber 60 becoming larger, the gas of the combustion chamber 5 flows into the sub chamber 60. At this time, sometimes the unburned fuel flows into the sub chamber 60. In the third combustion pressure control system, the shut-off valve 46 opens in the combustion period of the fuel. For this reason, even if the gas which flows from the sub chamber 60 to the combustion chamber 5 contains unburned fuel, the unburned fuel can be made to burn in the combustion chamber 5.

Further, after the combustion period of the fuel, the shut-off valve 46 is closed. The shut-off valve 46 is maintained in the closed stated until the exhaust valves 8 close. For this reason, it is possible to keep the gas of the sub chamber 60 including the unburned fuel from flowing into the combustion chamber 5 and remaining in the combustion chamber 5 without burning. In the subsequent exhaust stroke, it is possible to keep the unburned fuel from flowing out to the engine exhaust passage. Alternatively, it is possible to keep the amount of fuel consumption from becoming larger.

In the present embodiment, the shut-off valve 46 is controlled to open after the exhaust valves 8 close. The shut-off valve 46 is in an open state in the intake stroke. The gas which remained in the sub chamber 60 flows into the combustion chamber 5. The unburned fuel which is contained in the gas which remained in the sub chamber 60 can be made to burn in the next combustion period.

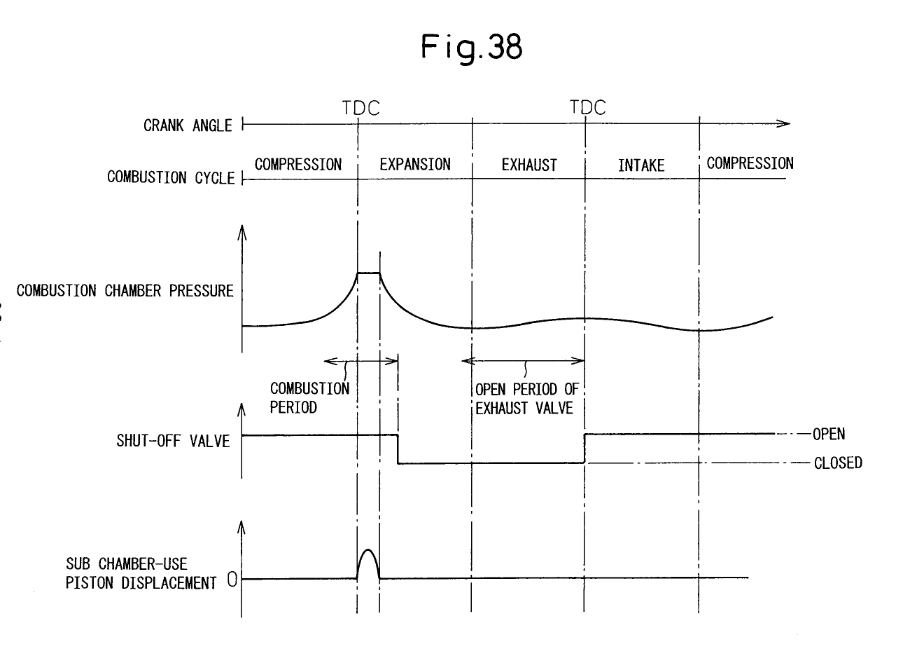

FIG. 38 is a time chart which explains another example of operation of the third combustion pressure control system in the present embodiment. FIG. 38 shows the case where fuel stops being burned after the period where the pressure of the combustion chamber reaches the control pressure. In another example of operation, during the combustion period, the open state of the shut-off valve 46 is maintained. Even in the case where the gas which flows into the sub chamber 60 contains unburned fuel, it is possible to make the unburned fuel burn in the combustion chamber 5. The shut-off valve 46 is closed upon detection of the end of the combustion period.

In the other example of operation of the third combustion pressure control system, the shut-off valve 46 is maintained in a closed state until the end of the period in which the exhaust valves 8 are open. For this reason, even when unburned fuel remains in the connecting pipe 50, it is possible to keep unburned fuel from flowing out to the engine exhaust passage in the exhaust stroke.

In this way, by arranging the shut-off valve in the connecting pipe and maintaining the shut-off valve in the closed state from the end of the combustion period to the end of the period in which the exhaust valves are open, it is possible to keep unburned fuel from being exhausted from the combustion chamber to the engine exhaust passage.

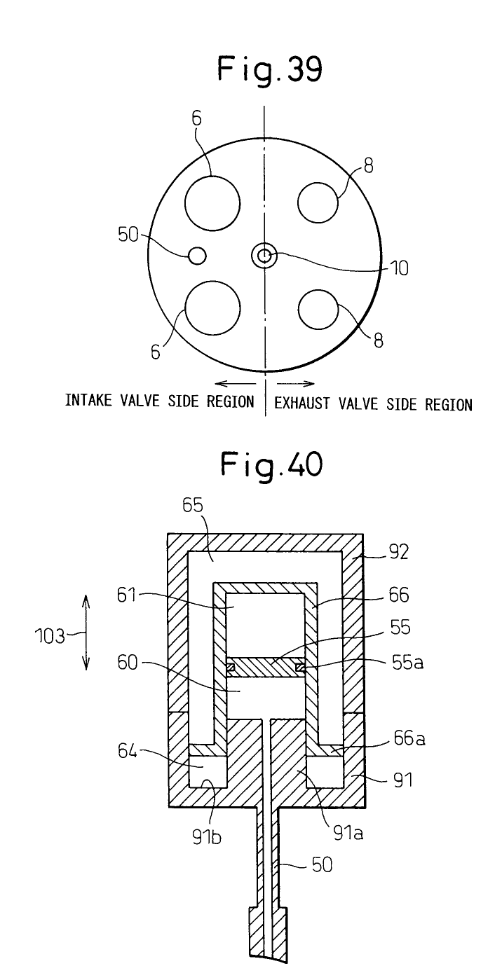

FIG. 39 is a schematic plan view of an internal combustion engine provided with a fourth combustion pressure control system of the present embodiment. FIG. 39 is a schematic view which explains the connecting position of the connecting pipe at the combustion chamber. The fourth combustion pressure control system is provided with a connecting pipe 50 which connects the combustion chamber and the sub chamber. The connecting pipe 50 is arranged near the intake valve 6. When viewing the combustion chamber from a plan view and dividing it into the region at the intake valve side and the region at the exhaust valve side, the connecting pipe 50 which is connected to the sub chamber is connected to the combustion chamber 5 at the region at the intake valve side. Furthermore, the connecting pipe 50 is arranged near the wall surface of the combustion chamber 5.

In the exhaust stroke of the combustion cycle, the piston 3 rises inside the combustion chamber 5. When the piston 3 rises, the piston ring which is arranged at the outer circumference of the piston 3 scrapes up the unburned fuel which was deposited on the inside surface of the combustion chamber 5. The scraped up unburned fuel is gathered near the exhaust valves 8 along the flow of the exhaust gas.

By connecting the connecting pipe 50 to the combustion chamber 5 at the region at the intake valve side, it is possible to suppress the unburned fuel from flowing to the inside of the connecting pipe 50 in the exhaust stroke. Alternatively, by arranging the connecting pipe 50 near the intake valves 6, it is possible to suppress unburned fuel from entering inside of the connecting pipe 50.

FIG. 40 is a schematic cross-sectional view of a fifth combustion pressure control system in the present embodiment. The fifth combustion pressure control system is provided with a base member 91 and a tubular member 66 forming the tubular part. The tubular member 66 in the present embodiment is formed by a material which has a heat insulating property. The base member 91 includes the connecting pipe 50. The base member 91 includes a projecting part 91a. The tubular member 66 is fit into the projecting part 91a. The biasing device of the fifth combustion pressure control system includes a gas chamber 61 which is formed so as to use gas pressure to bias the sub chamber-use piston 55 toward the combustion chamber side.

The gas chamber 61 is formed inside of the tubular member 66. The tubular member 66 in the present embodiment is formed so as to be able to move so that the volume of the gas chamber 61 changes. The tubular member 66, as shown by the arrow 103, is formed to be able to move in the axial direction of the tubular member 66. Further, in the present embodiment, a not shown fastening device is arranged for fastening the tubular member 66 at any position. The fastening device is formed so as to fasten the tubular member 66 to the base member 91 while the sub chamber-use piston 55 is moving and so as to release the hold on the tubular member 66 when the sub chamber-use piston 55 is seated.

The fifth combustion pressure control system in the present embodiment includes an auxiliary cylinder which is arranged in proximity to the sub chamber 60. The auxiliary cylinder in the present embodiment includes the flange part 66a of the tubular member 66 and the recess part 91b of the base member 91. The flange part 66a functions as an auxiliary piston. The auxiliary cylinder includes an auxiliary chamber 64 which is formed by the flange part 66a and the recess part 91b. The cross-sectional area of the auxiliary chamber 64 when cut in the direction vertical to the axial direction is formed to become equal to the cross-sectional area of the gas chamber 61 when cut in the direction vertical to the axial direction. The auxiliary chamber 64 in the present embodiment is formed to become the same volume as the gas chamber 61. The auxiliary chamber 64 has the same gas sealed in it as the gas chamber 61. Gas is sealed in the auxiliary chamber 64 so that the gas pressure of the gas chamber 61 when the sub chamber-use piston 55 is seated becomes the same as the gas pressure of the auxiliary chamber 64.

The fifth combustion pressure control system in the present embodiment includes a covering member 92 which is arranged to cover the tubular member 66. The covering member 92 is fastened to the base member 91. A pressurizing chamber 64 is formed surrounded by the covering member 92 and the tubular member 66. The pressurizing chamber 65 is filled with a gas of a predetermined pressure. Due to the gas pressure of the pressurizing chamber 65, when a fastening device is not used to fasten the tubular member 66 to the base member 91, the tubular member 66 can be prevented from being pulled out from the projecting part 91a.

Due to the inflow of burned gas into the sub chamber 60, the temperature of the inside of the sub chamber 60 rises. The heat of the sub chamber 60 is sometimes conducted resulting in a rise in the temperature inside of the gas chamber 61. When the volume of the gas chamber 61 is unchangeable or when no air feed device is connected, the pressure of the gas chamber 61 will sometimes rise and the control pressure will end up changing. In this way, the control pressure sometimes will end up changing due to the change in temperature of the gas chamber 61.

In the fifth combustion pressure control system, the combustion gas which flows into the sub chamber 60 passes through the connecting pipe 50. The heat of the connecting pipe 50 is transmitted through the projecting part 91a to the auxiliary chamber 64. Further, the heat of the sub chamber 60 is transmitted through the projecting part 91a to the auxiliary chamber 64. For this reason, the temperature of the auxiliary chamber 64 changes while tracking the change in temperature of the gas chamber 61. For example, when the temperature of the inside of the sub chamber 60 rises, the temperatures of the gas chamber 61 and the auxiliary chamber 64 rise. The tubular member 66 is formed by a material which has a heat insulating property, so a rise in the temperature of the pressurizing chamber 65 is suppressed. When the temperature of the auxiliary chamber 64 rises, the volume of the auxiliary chamber 64 becomes larger. The auxiliary piston comprised of the flange part 66a moves. The tubular member 66 moves and the volume of the gas chamber 61 becomes larger. The rise of the pressure at the inside of the gas chamber 61 is suppressed.

In this way, in the fifth combustion pressure control system, the auxiliary piston moves due to a change of temperature of the auxiliary chamber 64 of the auxiliary cylinder. Driven by the movement of the auxiliary piston, the tubular member 66 moves whereby the volume of the gas chamber 61 changes. Due to this configuration, even if the temperature at the inside of the gas chamber 61 changes, the pressure at the inside of the gas chamber 61 can be maintained substantially constant. That is, it is possible to maintain the control pressure substantially constant.

In the fifth combustion pressure control system, part of the tubular member is formed so as to become the auxiliary piston of the auxiliary cylinder, but the invention is not limited to this. The auxiliary cylinder may also be formed separated from the tubular member.

The rest of the configuration, action, and effects are similar to those of any of Embodiments 1 to 4, so the explanations will not be repeated here.

The above embodiments may be suitably combined. In the above-mentioned figures, the same or corresponding parts are assigned the same reference notations. Note that the above embodiments are illustrations and do not limit the invention. Further, in the embodiments, changes within the scope of the claims are intended.

### REFERENCE SIGNS LIST

5 . . . combustion chamber
10 . . . spark plug
31 . . . electronic control unit
51 . . . tubular member
55 . . . sub chamber-use piston
55a . . . piston ring
56 . . . gas chamber-use piston
56a . . . O-ring
57 . . . intermediate piston
57a . . . O-ring
58 . . . connecting rod
59 . . . partition part
60 . . . sub chamber
61 . . . gas chamber
62 . . . oil chamber

1. A combustion pressure control system of a spark ignition type of internal combustion engine which has a sub chamber which is communicated with a combustion chamber, wherein
the system is provided with a volume changing device which changes a volume of the sub chamber by a change of pressure of the combustion chamber serving as a driving source when the pressure of the combustion chamber reaches a control pressure,
a control pressure changing device for changing the control pressure, and
an operating state detecting device which detects an operating state of the internal combustion engine,
the control pressure is set in a range of larger than a maximum pressure of the combustion chamber in the case of suspending the supply of fuel and less than the pressure at which abnormal combustion of the fuel occurs, and
the volume changing device is formed so that when the pressure of the combustion chamber reaches the control pressure during the period from a compression stroke to an expansion stroke of a combustion cycle, the volume of the sub chamber becomes larger and a rise of the pressure of the combustion chamber is suppressed,
the volume changing device includes a tubular part which is communicated with the combustion chamber, a moving member which is arranged movably at the inside of the tubular part and which defines a space at the inside of the tubular part to form a sub chamber at the side facing the combustion chamber, and a biasing device which biases the moving member toward the combustion chamber so that the moving member starts to move at the control pressure, the volume of the sub chamber changes by the moving member moving through the inside of the tubular part,
the biasing device includes a gas chamber which is formed to use gas pressure to bias the moving member toward the combustion chamber side,
the control pressure, which continuously changes based on the operating state of the internal combustion engine, is determined in advance, and
the control pressure changing device changes the pressure of the gas chamber so as to give a control pressure corresponding to operating state of the internal combustion engine.

2. (canceled)

3. A combustion pressure control system as set forth in claim 1, wherein
the operating state detecting device detects a speed of the internal combustion engine, and
the control pressure changing device increases the control pressure the larger the speed which is detected.

4. A combustion pressure control system as set forth in claim 1, wherein
the system is provided with a fuel property detecting device for detecting a property of the fuel and
the control pressure changing device changes the control pressure based on the property of the fuel which is detected by the fuel property detecting device.

5. A combustion pressure control system as set forth in claim 4, wherein
the system is a combustion pressure control system of an internal combustion engine which burns fuel which contains alcohol,
the fuel property detecting device detects a concentration of alcohol which is contained in the fuel, and
the control pressure changing device increases the control pressure the larger the concentration of alcohol which is detected.

6. A combustion pressure control system as set forth in claim 1, wherein the system advances the ignition timing when an amount of fuel which is fed to the combustion chamber is larger than a predetermined feed judgment value or when a temperature of exhaust gas is higher than a predetermined temperature judgment value.

7. (canceled)

8. A combustion pressure control system as set forth in claim 1, wherein
the moving member includes a sub chamber-use piston which is arranged at the inside of the tubular part, and
the control pressure changing device temporarily lowers the speed of movement of the sub chamber-use piston when the pressure of the combustion chamber falls and the sub chamber-use piston moves toward the combustion chamber side.

9. A combustion pressure control system as set forth in claim 1, wherein
the moving member includes a sub chamber-use piston which is arranged at the inside of the tubular part, a gas chamber-use piston which is arranged at the inside of the tubular part and which is fastened to the sub chamber-use piston through a connecting rod, and an intermediate piston which is arranged at the inside of the tubular part between the sub chamber-use piston and the gas chamber-use piston,
a space sandwiched between the gas chamber-use piston and the intermediate piston is filled with oil, and the gas chamber-use piston, intermediate piston, and sub chamber-use piston move integrally through the inside of the tubular part.

10. A combustion pressure control system as set forth in claim 9, wherein
the volume changing device is provided with a partition part which is fastened to the tubular part and is arranged between the gas chamber-use piston and the intermediate piston,
the partition part has arranged at it a first check valve through which oil flows when the volume of the sub chamber becomes large and a second check valve through which oil flows when the volume of the sub chamber becomes small, and
the second check valve is formed to have a smaller maximum flow rate than the first check valve.

11. A combustion pressure control system as set forth in claim 9, wherein
a first sealing member is arranged between the sub chamber-use piston and the tubular part,
a second sealing member is arranged between the intermediate piston and the tubular part,
a movement region of the first sealing member in the inner surface of the tubular part is formed with grooves for storage of oil, and
the second sealing member moves in the region outside of the movement region of the first sealing member.

12. A combustion pressure control system as set forth in claim 1, wherein
the system is a combustion pressure control system of an internal combustion engine which is provided with a plurality of combustion chambers and has a volume changing device arranged at each of the combustion chambers, and
the plurality of gas chambers which are arranged for the combustion chambers are connected with each other.

13. A combustion pressure control system as set forth in claim 1, wherein the biasing device includes an auxiliary tank which is connected to the gas chamber.

14. A combustion pressure control system as set forth in claim 1, wherein
the system is provided with an auxiliary cylinder which includes an auxiliary chamber in which a gas is sealed and an auxiliary piston and is arranged in proximity to the sub chamber, and
the tubular part is formed to be able to move so that the volume of the gas chamber changes and
the system is formed so that a change of temperature of the auxiliary chamber of the auxiliary cylinder causes the auxiliary piston to move, the movement of the auxiliary piston is used to drive movement of the tubular part, and the volume of the gas chamber is thereby changed.

15. A combustion pressure control system as set forth in claim 1, wherein
the volume changing device includes a connecting pipe which has a diameter smaller than the diameter of the sub chamber,
the tubular part is communicated with the combustion chamber through the connecting pipe, and
the connecting pipe is connected to the combustion chamber in a region at the inside of a circle around an ignition device when defining a circle along the outer shape of the combustion chamber so as to pass through the centers of circles of planar shapes of intake valves.
